(19) United States
(12) Patent Application Publication
(10) Pub. No.: US 2017/0000143 A1
(43) Pub. Date: Jan. 5, 2017

(54) A METHOD OF INDUCING RIPENESS IN FRUIT

(71) Applicant: BAYER CROPSCIENCE AKTIENGESELLSCHAFT, Monheim am Rhein (DE)

(72) Inventor: SHANE MARK TRAINER, MOUNT WAVERLEY VICTORIA (AU)

(73) Assignee: Bayer Cropscience AG, Monheim (DE)

(21) Appl. No.: 15/115,315

(22) PCT Filed: Jan. 29, 2015
(86) PCT No.: PCT/EP2015/051802

§ 371 Date: Jul. 29, 2016

(30) Foreign Application Priority Data
Jan. 31, 2014 (EP) 14153450.3

(51) Int. Cl. A23B 7/154; A23L 2/02

(52) U.S. Cl. CPC A23B 7/154; A23L 2/02; A23V 2002/00

(57) ABSTRACT

The present invention is directed to compounds and methods for inducing ripeness in fruit, increasing the organoleptic properties of fruit, and/or improving desirable characteristics in fruit.

### FIELD OF THE INVENTION

Broadly, the present invention is directed to compounds and methods for inducing ripeness in fruit, increasing the organoleptic properties of fruit, and/or improving desirable characteristics in fruit.

### BACKGROUND OF THE INVENTION

Adverse weather events, such as storms, frost, and hail, can severely damage or destroy fruit crops before they are ready for harvest. Shortening the time fruit is on the plant, vine, or tree reduces the risk of weather related damage, but the fruit may be harvested at suboptimal times such that the fruit is not yet sufficiently ripe.

In some cases, such as with many climacteric fruit, the fruit may be intentionally harvested before it is ripe when conditions are favourable to harvest and the fruit is at its peak for harvest. Non-climacteric fruit ripen on the plant, vine, or tree such that once the fruit is harvested, the fruit's desirable properties, such as taste, colour, and texture, typically do not improve. Examples of non-climacteric fruit include grapes, cherries, strawberries, pineapples, raspberries, and citrus. Because non-climacteric fruit are ideally ripe when they are harvested, non-climacteric fruit can be more difficult to store, and spoil more easily than climacteric fruit. This is where adverse weather conditions can play a pivotal role. If a storm or hail is predicted and the fruit is not quite ripe, the fruit may be picked early at a suboptimum time leading to an inferior fruit product. Reducing the amount of time fruit spends on the plant, tree, or vine reduces the changes of adverse weather related events spoiling a crop.

However, fruit picked early when it is not sufficiently ripe is likely to have lower levels of total soluble solids (TSS) and higher amounts of acid measured by its titratable activity (TA) (often referred to as the “total acidity”). As fruit ripens, the amount of sugar (soluble solids) typically increases and the acidity falls. Fruit with lower levels of TSS and higher TA are perceived as being sour or tart and are generally not preferred by consumers compared to fruit that has higher levels of TSS and lower TA. Essentially, consumers prefer fruit that is ripe as it has more organoleptically appealing properties, such as colour, taste (sweetness), and texture.

There is thus a need to induce ripeness in fruit that does not adversely effect the fruit qualities prized by consumers.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

In a first aspect, the present invention provides a method of inducing ripeness in a fruit, the method comprising exposing a plant from which the fruit grows, the fruit, roots of the plant, leaves of the plant, seed of the plant, or soil or substrate in which the plant grows or is to be grown, to a compound of formula I

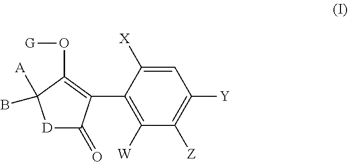

in which
X is selected from halogen, alkyl, alkoxy, haloalkyl, haloalkoxy, or cyano,
W, Y and Z independently of one another are selected from hydrogen, halogen, alkyl, alkoxy, haloalkyl, haloalkoxy, or cyano,
A is selected from hydrogen, alkyl, alkoxyalkyl, optionally substituted cycloalkyl, or optionally substituted heterocycloalkyl, wherein said alkyl and alkoxyalkyl are optionally substituted by halogen,
B is selected from hydrogen or alkyl,
or
A and B together with the carbon atom to which they are attached form a saturated or unsaturated, optionally substituted carbocyclic ring or form a saturated or unsaturated, optionally substituted heterocyclic ring,
D is selected from NH or oxygen,
G is hydrogen (a) or is selected from one of (b) to (g)

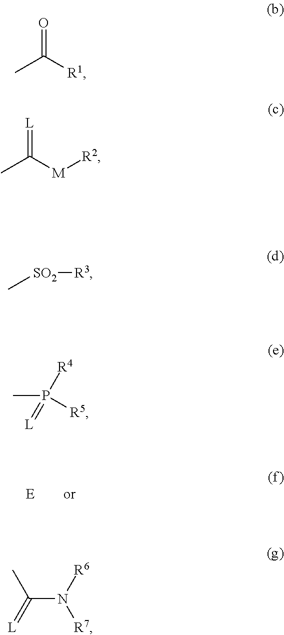

in which
E is selected from a metal ion or an ammonium ion,
L is selected from oxygen or sulphur,
M is selected from oxygen or sulphur,
R¹ is selected from alkyl, alkenyl, alkoxyalkyl, alkylthioalkyl, polyalkoxyalkyl, cycloalkyl, heterocycloalkyl, optionally substituted phenyl, optionally substituted phenylalkyl, optionally substituted hetaryl, optionally substituted phenoxyalkyl, or optionally substituted hetaryloxyalkyl, wherein said alkyl, alkenyl, alkoxyalkyl, alkylthioalkyl, and polyalkoxyalkyl are optionally substituted by halogen and said cycloalkyl and heterocycloalkyl are optionally substituted by halogen-alkyl or halogen-alkoxy,
R² is selected from alkyl, alkenyl, alkoxyalkyl, polyalkoxyalkyl, optionally substituted cycloalkyl, optionally substituted phenyl, or optionally substituted benzyl, wherein said alkyl, alkenyl, alkoxyalkyl, and polyalkoxyalkyl are optionally substituted by halogen,
R³ is selected from alkyl optionally substituted by halogen or optionally substituted phenyl,
R⁴ and R⁵ independently of one another are selected from alkyl, alkoxy, alkylamino, dialkylamino, alkylthio, alkenylthio, cycloalkylthio, optionally substituted phenyl, optionally substituted benzyl, optionally substituted phenoxy, or optionally substituted phenylthio, wherein said alkyl, alkoxy, alkylamino, dialkylamino, alkylthio, alkenylthio, and cycloalkylthio are optionally substituted by halogen, and
R⁶ and R⁷ independently of one another are selected from hydrogen, alkyl, cycloalkyl, alkenyl, alkoxy, alkoxyalkyl, optionally substituted phenyl, or optionally substituted benzyl, or together with the nitrogen atom to which they are attached form an optionally saturated or unsaturated, optionally substituted heterocyclic ring, wherein said alkyl, cycloalkyl, alkenyl, alkoxy, and alkoxyalkyl are optionally substituted by halogen,
   or an isomer mixture, pure isomer, or salt thereof, optionally in combination with one or more of a carrier, adjuvant, auxiliary, or extender.

In one embodiment, in the compound of formula I the radicals may have the following meanings:
W is selected from hydrogen, C₁-C₄-alkyl, C₁-C₄-alkoxy, chlorine, bromine, or fluorine,
X is selected from C₁-C₄-alkyl, C₁-C₄-alkoxy, C₁-C₄-haloalkyl, fluorine, chlorine, or bromine,
Y and Z independently of one another are selected from hydrogen, C₁-C₄-alkyl, halogen, C₁-C₄-alkoxy, or C₁-C₄-haloalkyl,
A is selected from hydrogen or C₁-C₆-alkyl or C₃-C₈-cycloalkyl, which are each optionally substituted by halogen,
B is selected from hydrogen, methyl, or ethyl, or
A, B and the carbon atom to which they are attached form a saturated C₃-C₆-cycloalkyl or C₃-C₆-heterocycloalkyl which contains one heteroatom selected from oxygen or sulphur, wherein said C₃-C₆-cycloalkyl or C₃-C₆-heterocycloalkyl are optionally substituted by one or two C₁-C₄-alkyl, or C₁-C₄-alkoxy groups,
D is selected from NH or oxygen,
G is hydrogen (a) or is selected from one of the groups (b) to (g)

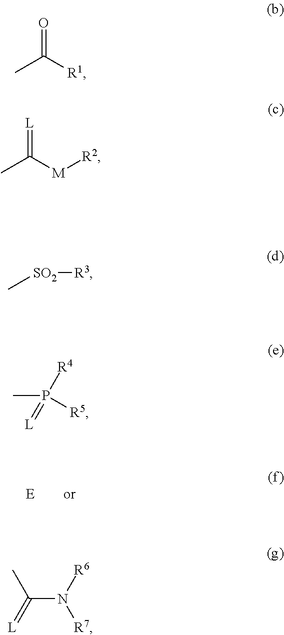

in which
E is selected from a metal ion or an ammonium ion,
L is selected from oxygen or sulphur,
M is selected from oxygen or sulphur,
R¹ is selected from C₁-C₁₀-alkyl, C₂-C₁₀-alkenyl, C₁-C₄-alkoxy-C₁-C₄-alkyl, C₁-C₄-alkylthio-C₁-C₄-alkyl, C₃-C₆-cycloalkyl, phenyl, pyridyl, or thienyl, wherein said C₁-C₁₀-alkyl, C₂-C₁₀-alkenyl, C₁-C₄-alkoxy-C₁-C₄-alkyl, and C₁-C₄-alkylthio-C₁-C₄-alkyl are optionally substituted by halogen, said C₃-C₆-cycloalkyl is optionally substituted by fluorine, chlorine, C₁-C₄-alkyl, or C₁-C₂-alkoxy, said phenyl is optionally substituted by fluorine, chlorine, bromine, cyano, nitro, C₁-C₄-alkyl, C₁-C₄-alkoxy, trifluoromethyl, or trifluoromethoxy, and said pyridyl and thienyl are optionally substituted by chlorine or methyl,
R² is selected from C₁-C₁₀-alkyl, C₂-C₁₀-alkenyl, C₁-C₄-alkoxy-C₂-C₄-alkyl, C₅-C₆-cycloalkyl, phenyl, or benzyl, wherein said C₁-C₁₀-alkyl, C₂-C₁₀-alkenyl, and C₁-C₄-alkoxy-C₂-C₄-alkyl are optionally substituted by fluorine or chlorine, said C₅-C₆-cycloalkyl is optionally substituted by methyl or methoxy, and said phenyl and benzyl are optionally substituted by fluorine, chlorine, bromine, cyano, nitro, C₁-C₄-alkyl, C₁-C₄-alkoxy, trifluoromethyl, or trifluoromethoxy,
R³ is selected from C₁-C₄-alkyl or phenyl, wherein said C₁-C₄-alkyl is optionally substituted by fluorine and said phenyl is optionally substituted by fluorine, chlorine, bromine, C₁-C₄-alkyl, C₁-C₄-alkoxy, trifluoromethyl, trifluoromethoxy, cyano, or nitro,
R⁴ is selected from C₁-C₄-alkyl, C₁-C₄-alkoxy, C₁-C₄-alkylamino, C₁-C₄-alkylthio, phenyl, phenoxy, or phenylthio, wherein said C₁-C₄-alkyl, C₁-C₄-alkoxy, C₁-C₄-alkylamino, and C₁-C₄-alkylthio are optionally substituted by fluorine or chlorine and said phenyl, phenoxy, and phenylthio are optionally substituted by fluorine, chlorine, bromine, nitro, cyano, C₁-C₄-alkoxy, trifluoromethoxy, C₁-C₄-alkylthio, C₁-C₄-haloalkylthio, C₁-C₄-alkyl, or trifluoromethyl,
R⁵ is selected from C₁-C₄-alkoxy or C₁-C₄-thioalkyl,
R⁶ is selected from C₁-C₆-alkyl, C₃-C₆-cycloalkyl, C₁-C₆-alkoxy, C₃-C₆-alkenyl, or C₁-C₄-alkoxy-C₁-C₄-alkyl,
R⁷ is selected from C₁-C₆-alkyl, C₃-C₆-alkenyl, or C₁-C₄-alkoxy-C₁-C₄-alkyl, or
R⁶ and R⁷ together with the nitrogen to which they are attached form a C₃-C₆-heterocycloalkylene group which optionally has one carbon atom replaced by oxygen or sulphur, wherein said C₃-C₆-heterocycloalkylene group is optionally substituted by methyl or ethyl,
   or an isomer mixture, pure isomer, or salt thereof.

In an embodiment, in the compound of formula I the radicals may have the following meaning:
G is hydrogen (a) or is selected from one of the groups (b), (c), (f), or (g)

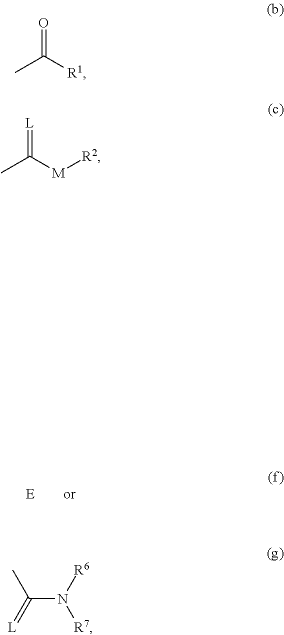

in which
E is selected from a metal ion or an ammonium ion,
L is selected from oxygen or sulphur,
M is selected from oxygen or sulphur,
R¹ is selected from C₁-C₁₀-alkyl, C₂-C₁₀-alkenyl, C₁-C₄-alkoxy-C₁-C₄-alkyl, C₁-C₄-alkylthio-C₁-C₄-alkyl, C₃-C₆-cycloalkyl, phenyl, pyridyl, or thienyl, wherein said C₁-C₁₀-alkyl, C₂-C₁₀-alkenyl, C₁-C₄-alkoxy-C₁-C₄-alkyl, and C₁-C₄-alkylthio-C₁-C₄-alkyl are optionally substituted by halogen, said C₃-C₆-cycloalkyl is optionally substituted by fluorine, chlorine, C₁-C₄-alkyl, or C₁-C₂-alkoxy, said phenyl is optionally substituted by fluorine, chlorine, bromine, cyano, nitro, C₁-C₄-alkyl, C₁-C₄-alkoxy, trifluoromethyl, or trifluoromethoxy, and said pyridyl or thienyl are optionally substituted by chlorine or methyl,
R² is selected C₁-C₁₀-alkyl, C₂-C₁₀-alkenyl, C₁-C₄-alkoxy-C₂-C₄-alkyl, C₅-C₆-cycloalkyl, phenyl or benzyl, wherein said C₁-C₁₀-alkyl, C₂-C₁₀-alkenyl, and C₁-C₄-alkoxy-C₂-C₄-alkyl are optionally substituted by fluorine or chlorine, said C₅-C₆-cycloalkyl is optionally substituted by methyl or methoxy, and said phenyl and benzyl are optionally substituted by fluorine, chlorine, bromine, cyano, nitro, C₁-C₄-alkyl, C₁-C₄-alkoxy, trifluoromethyl, or trifluoromethoxy,
R⁶ is selected from C₁-C₆-alkyl, C₃-C₆-cycloalkyl, C₁-C₆-alkoxy, C₃-C₆-alkenyl, or C₁-C₄-alkoxy-C₁-C₄-alkyl, and
R⁷ is selected from C₁-C₆-alkyl, C₃-C₆-alkenyl, or C₁-C₄-alkoxy-C₁-C₄-alkyl,
   or an isomer mixture, pure isomer, or salt thereof.

In an embodiment, in the compound of formula I the radicals may have the following meaning:
W is selected from hydrogen, methyl, ethyl, chlorine, bromine, or methoxy,
X is selected from chlorine, bromine, methyl, ethyl, propyl, isopropyl, methoxy, ethoxy, or trifluoromethyl,
Y and Z independently of one another are selected from hydrogen, fluorine, chlorine, bromine, methyl, ethyl, propyl, isopropyl, trifluoromethyl, or methoxy,
A is selected from methyl, ethyl, propyl, isopropyl, butyl, isobutyl, sec-butyl, tert-butyl, cyclopropyl, cyclopentyl, or cyclohexyl,
B is selected from hydrogen, methyl, or ethyl,
or
A, B and the carbon atom to which they are attached form a saturated C₅-C₆-cycloalkyl or C₅-C₆-heterocycloalkyl which has one ring member replaced by oxygen, wherein said C₅-C₆-cycloalkyl and C₅-C₆-heterocycloalkyl are optionally monosubstituted by methyl, ethyl, methoxy, ethoxy, propoxy, or butoxy,
D is selected from NH or oxygen,
G is hydrogen (a) or is selected from one of the groups (b), (c), (f), or (g)

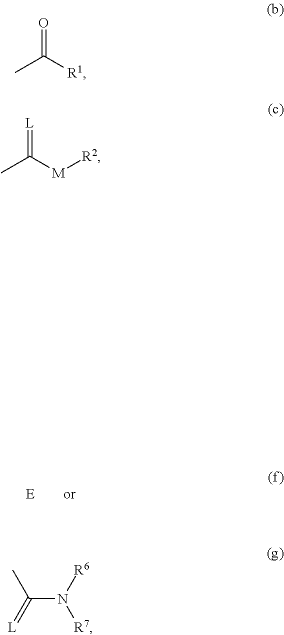

in which
E is selected from a metal ion or an ammonium ion,
M is selected from oxygen or sulphur,
R¹ is selected from C₁-C₈-alkyl, C₂-C₄-alkenyl, methoxymethyl, ethoxymethyl, ethylthiomethyl, cyclopropyl, cyclopentyl, cyclohexyl, phenyl, pyridyl, or thienyl, wherein said phenyl is optionally mono- or disubstituted by fluorine, chlorine, bromine, cyano, nitro, methyl, ethyl, methoxy, trifluoromethyl, or trifluoromethoxy and said pyridyl and thienyl are optionally substituted by chlorine or methyl,
R² is selected from C₁-C₈-alkyl, C₂-C₄-alkenyl, methoxyethyl, ethoxyethyl, phenyl, or benzyl,
R⁶ and R⁷ independently of one another are selected from methyl, ethyl, or together with the nitrogen to which they are attached from a C₅-heteroalkylene radical in which the C₃-methylene group has been replaced by an oxygen,
   or an isomer mixture, pure isomer, or salt thereof.

In an embodiment, in the compound of formula I the radicals have the following meaning:
W is selected from hydrogen or methyl,
X is selected from chlorine, bromine, or methyl,
Y and Z independently of one another are selected from hydrogen, chlorine, bromine, or methyl,
A, B and the carbon atom to which they are attached form a C₅-C₆-cycloalkyl or C₅-C₆-heterocycloalkyl which has one ring member replaced by oxygen, wherein said C₅-C₆-cycloalkyl and C₅-C₆-heterocycloalkyl are optionally monosubstituted by methyl, methoxy, ethoxy, propoxy, or butoxy,
D is selected from NH or oxygen,
G is hydrogen (a) or is selected from one of the groups (b), (c), or (g)

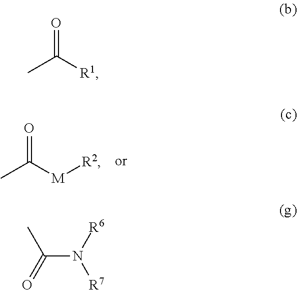

in which
M is selected from oxygen or sulphur,
R¹ is selected from C₁-C₈-alkyl, C₂-C₄-alkenyl, methoxymethyl, ethoxymethyl, ethylthiomethyl, cyclopropyl, cyclopentyl, cyclohexyl, phenyl, pyridyl, or thienyl, wherein said phenyl is optionally monosubstituted by fluorine, chlorine, bromine, methyl, methoxy, trifluoromethyl, trifluoromethoxy, cyano, or nitro and said pyridyl and theinyl are optionally substituted by chlorine or methyl,
R² is selected from C₁-C₈-alkyl, C₂-C₄-alkenyl, methoxyethyl, ethoxyethyl, phenyl, or benzyl,
R⁶ and R⁷ independently of one another is selected from methyl, ethyl, or together with the nitrogen to which they are attached form a C₅-heteroalkylene radical in which the C₃-methylene group has been replaced by an oxygen,
   or an isomer mixture, pure isomer, or salt thereof.

In a particular embodiment, the compound of formula I is selected from the group consisting of

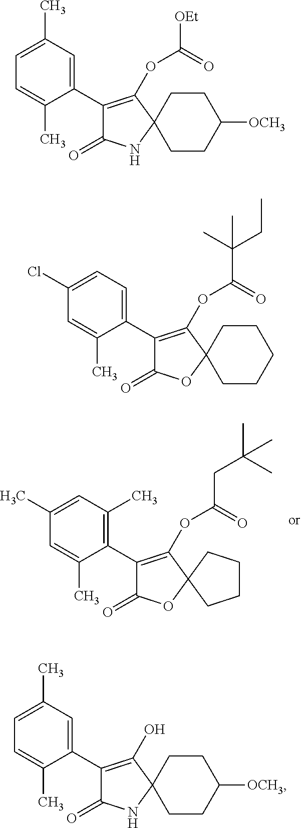

or an isomer mixture, pure isomer, or salt thereof.

In an embodiment, the compound of formula I is

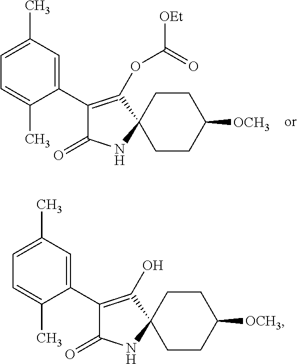 [SMILES: CCOC(=O)OC1=C(c2cc(C)ccc2C)C(=O)N[C@]12CC[C@@H](OC)CC2 ; CO[C@H]1CC[C@]2(CC1)NC(=O)C(c1cc(C)ccc1C)=C2O]

or an isomer mixture, pure isomer, or salt thereof.

In an embodiment, the compound of formula I is

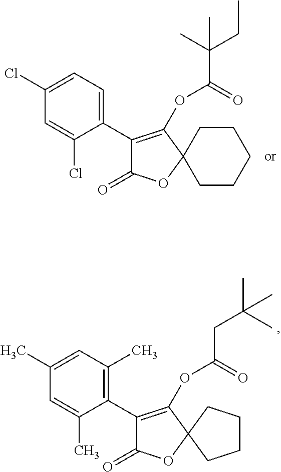 [SMILES: CCC(C)(C)C(=O)OC1=C(c2ccc(Cl)cc2Cl)C(=O)OC12CCCCC2 ; Cc1cc(C)c(C2=C(OC(=O)CC(C)(C)C)C3(CCCC3)OC2=O)c(C)c1]

or an isomer mixture, pure isomer, or salt thereof.

In an embodiment, the compound of formula I is

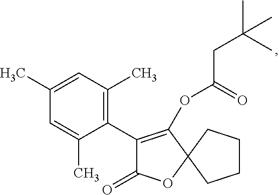 [SMILES: Cc1cc(C)c(C2=C(OC(=O)CC(C)(C)C)C3(CCCC3)OC2=O)c(C)c1]

or an isomer mixture, pure isomer, or salt thereof.

In an embodiment, the compound of formula I is

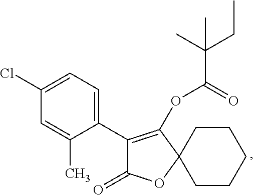 [SMILES: CCC(C)(C)C(=O)OC1=C(c2ccc(Cl)cc2C)C(=O)OC12CCCCC2]

or an isomer mixture, pure isomer, or salt thereof.

In an embodiment, the compound of formula I is

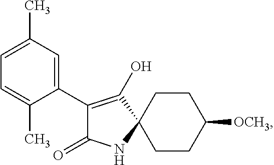 [SMILES: CO[C@H]1CC[C@]2(CC1)NC(=O)C(c1cc(C)ccc1C)=C2O]

or a salt thereof.

In an embodiment, the compound of formula I is

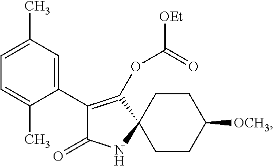 [SMILES: CCOC(=O)OC1=C(c2cc(C)ccc2C)C(=O)N[C@]12CC[C@@H](OC)CC2]

or a salt thereof.

In an embodiment, the adjuvant may predominantly comprise methyl or ethyl esters (or mixtures thererof) of fatty acids originating from plant oils, optionally the plant oils may be selected from sunflower oil, canola oil, rapeseed oil, soybean oil, corn oil, or the like. In an embodiment of the present invention, the adjuvant may be a polyalkoxylated triglyceride. In an embodiment, the adjuvant may be a C₈-C₁₀ polyethoxylated fatty alcohol. In another embodiment of the present invention, the adjuvant may be a C₈-C₁₀ polyalkoxylated fatty alcohol.

By way of example the fruit may be citrus, pome or stone fruit, berries or grapes. The citrus fruit may be, for example, oranges, limes, lemons, grapefruit, mandarins, tangerines, tangelos and the like. The pome fruit may be, for example, apples or pears. The stone fruit may be, for example, plums, peaches, apricots or nectarines. The berries may be, for example, blueberries, raspberries, strawberries or blackberries.

In a particular embodiment the fruit are grapes. The grapes may be table grapes or wine grapes.

In a particular embodiments, the fruit and/or plant is exposed to the compound of formula I. The leaves of the plant may be exposed to the compound. In an embodiment, the fruit and the plant are exposed to the compound of formula I by spraying. In an embodiment, the leaves of the plant are exposed to the compound of formula I by spraying.

In an embodiment, the compound of formula I is applied with one or more further agriculturally acceptable compounds, such as herbicides, pesticides, insecticides, fungicides, or plant or fruit growth promoting agents.

In a second aspect, the present invention provides a method of reducing the ripening time of a fruit, the method comprising exposing a plant from which the fruit grows, the fruit, roots of the plant, leaves of the plant, seed of the plant, or soil or substrate in which the plant grows or is to be grown, to a compound of formula I as defined in the first aspect, optionally in combination with one or more of a carrier, adjuvant, auxiliary, or extender.

In a third aspect, the present invention provides a method of increasing the palatability of a fruit, the method comprising exposing a plant from which the fruit grows, the fruit, roots of the plant, leaves of the plant, seed of the plant, or soil or substrate in which the plant grows or is to be grown, to a compound of formula I as defined in the first aspect, optionally in combination with one or more of a carrier, adjuvant, auxiliary, or extender.

In a fourth aspect, the present invention provides a method of improving desirable characteristics in a fruit, the method comprising exposing a plant from which the fruit grows, the fruit, roots of the plant, leaves of the plant, seed of the plant, or soil or substrate in which the plant grows or is to be grown, to a compound of formula I as defined in the first aspect, optionally in combination with one or more of a carrier, adjuvant, auxiliary, or extender.

In a fifth aspect, the present invention provide a method of improving organoleptic properties of a fruit, the method comprising exposing a plant from which the fruit grows, the fruit, roots of the plant, leaves of the plant, seed of the plant, or soil or substrate in which the plant grows or is to be grown, to a compound of formula I as defined in the first aspect, optionally in combination with one or more of a carrier, adjuvant, auxiliary, or extender.

In a sixth aspect, the present invention provides fruit juice obtained from fruit which has been exposed to a compound of formula I according to the method of any one of the first to fifth aspects.

In a further aspect, the present invention provides a compound of formula I as defined in the first aspect, optionally in combination with one or more of a carrier, adjuvant, auxiliary, or extender, for inducing ripeness in a fruit.

In a further aspect, the present invention provides a compound of formula I as defined in the first aspect, optionally in combination with one or more of a carrier, adjuvant, auxiliary, or extender, for reducing the ripening time of a fruit.

In a further aspect, the present invention provides a compound of formula I as defined in the first aspect, optionally in combination with one or more of a carrier, adjuvant, auxiliary, or extender, for increasing the palatability of a fruit.

In a further aspect, the present invention provides a compound of formula I as defined in the first aspect, optionally in combination with one or more of a carrier, adjuvant, auxiliary, or extender, for improving desirable characteristics in a fruit.

In a further aspect, the present invention provides a compound of formula I as defined in the first aspect, optionally in combination with one or more of a carrier, adjuvant, auxiliary, or extender, for improving the organoleptic properties of a fruit.

In a further aspect, the present invention provides a use of a compound of formula I as defined in the first aspect, optionally in combination with one or more of a carrier, adjuvant, auxiliary, or extender, for inducing ripeness in a fruit.

In a further aspect, the present invention provides a use of a compound of formula I as defined in the first aspect, optionally in combination with one or more of a carrier, adjuvant, auxiliary, or extender, for reducing the ripening time of a fruit.

In a further aspect, the present invention provides a use of a compound of formula I as defined in the first aspect, optionally in combination with one or more of a carrier, adjuvant, auxiliary, or extender, for increasing the palatability of a fruit.

In a further aspect, the present invention provides a use of a compound of formula I as defined in the first aspect, optionally in combination with one or more of a carrier, adjuvant, auxiliary, or extender, for improving desirable characteristics in a fruit.

In a further aspect, the present invention provides a use of a compound of formula I as defined in the first aspect, optionally in combination with one or more of a carrier, adjuvant, auxiliary, or extender, for improving the organoleptic properties of a fruit.

Although the present invention is broadly as defined above, those persons skilled in the art will appreciate that the invention is not limited thereto and that the invention also includes embodiments of which the following description gives examples.

The embodiments of the invention described above are intended to be merely exemplary, and those skilled in the art will recognise, or will be able to ascertain using no more than routine experimentation, numerous equivalents of specific materials, compounds, and procedures. All such equivalents are considered to be within the scope of the invention as set out in the accompanying claims.

### BRIEF DESCRIPTION OF THE FIGURES

Embodiments of the invention are described herein with reference, by way of example only, to the following drawings.

FIG. 1: changes in Hue and L* values for grapes treated with MOVENTO® or left as untreated controls over time at 20° C., with a final measurement after 29 days at 0° C. (hollow marker). Data generated using average values per tray of berries by the described photographic method. Bars indicate the standard error of each mean value (n=8).

FIG. 2: changes in a* and b* values for grapes treated with MOVENTO® or left as untreated controls over time at 20° C., with a final measurement after 29 days at 0° C. (hollow marker). Data generated using average values per tray of berries by the described photographic method. Bars indicate the standard error of each mean value (n=8).

FIG. 3: differences in light absorbance between samples of juice extracted from treated and untreated grapes, measured with a scanning spectrophotometer.

FIG. 4: the difference between average absorbance (control fruit) minus average absorbance (treated fruit), n=8. The spectrum indicates the visible colours corresponding to measured wavelengths.

FIG. 5: total soluble solids in juice extracted from treated and untreated grapes harvested in Western Australia at 0° C. or 20° C. for up to 50 or 25 days, respectively. Bars indicate the standard error of each mean value (n=8).

FIG. 6: titratable acidity, expressed as mmol equivalents to NaOH, in juice extracted from treated and untreated grapes harvested in Western Australia then stored at 0° C. or 20° C. for up to 34 or 25 days, respectively. Bars indicate the standard error of each mean value (n=8).

FIG. 7: berry size, expressed in mm, of berries of Menindee seedless grapes from crops treated with MOVENTO® 240SC (240 g ai/L spirotetramat) with an adjuvant (BIOPEST® or AGRIDEX®) or TRANSFORM® (40 mL/100 L).

### DETAILED DESCRIPTION OF THE INVENTION

As used herein, the articles “a” and “an” refer to one or to more than one (i.e., to at least one) of the grammatical object of the article. By way of example, “an element” means one element or more than one element.

As used herein, the term “about” is understood to refer to a range of numbers that a person of skill in the art would consider equivalent to the recited value in the context of achieving the same function or result.

As used herein, “(s)” following a noun means the plural and/or singular forms of the noun.

As used herein, the term “and/or” means “and” or “or” or both.

As used herein throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

As used herein, it is intended that reference to a range of numbers (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein, the term “carrier” includes a natural or synthetic, organic or inorganic solid or liquid substance with which an active compound is mixed or bonded, for example to provide better applicability, in particular for application to plants or parts of plants. The carrier, which may be solid or liquid, is generally inert and should be suitable for use in agriculture.

As used herein, the term “adjuvant” includes an agent that modifies the effect of the active compound for use in the present invention. Suitable adjuvants include inorganic or organic chemicals and macromolecules, or any mixtures thereof. In particular embodiments of the present invention, the adjuvant may predominantly consist of methyl or ethyl esters (or mixtures thererof) of fatty acids originating from plant oils, optionally the plant oils may be selected from sunflower oil, canola oil, rapeseed oil, soybean oil, corn oil or like. By way of example, suitable adjuvants for use in the present invention include HASTEN®, KWICKEN®, UPTAKE®, ROCKET®, AUREO®, STEFES MERO®, DYNE-AMIC®, BIOPEST®, AGRIDEX® and ZAP®. In another embodiment of the present invention, the adjuvant may be from the class of polyalkoxylated triglycerides that may be described by CAS 70377-91-2 or CAS 165658-61-7 and that are commercially available, optionally under the brand names Crovol A 70 UK®, Crovol CR 70 G®, Crovol M 70® and Crovol PK 70® from Croda and Radia 6107® from Oleon. In an embodiment, the adjuvant may be selected from a class of C₈-C₁₀ polyethoxylated fatty alcohols. By way of example, suitable adjuvants may be selected from the class of polyethoxylated alcohols that may be described by CAS 9043-30-5 (GENAPOL X080) or 27213-90-7 (GENAPOL C₁₀₀) and that are commercially available, optionally under the brand name(s) Genapol X® and Genapol C®, respectively. In another embodiment of the present invention, the adjuvant may be selected from a class of C₈-C₁₀ polyalkoxylated fatty alcohols. By way of example, suitable adjuvants may be selected from the class of polypropoxylated-ethoxylated alcohols that may be described by CAS 64366-70-7 and that is commercially available, optionally under the brand name Tanemul HOT 5902.

As used herein, the term “exposing” means generally bringing into contact with. Exposure may be direct or indirect. Exposure of fruit and/or a plant to a compound of formula I (e.g. spirotetramat) includes administration of the compound to the fruit or plant, or otherwise bringing the fruit and/or plant or a part of the plant (e.g. leaves or roots) into contact with the compound itself, such as by spraying, immersion, or contacting a surface or solution in which the plant and/or fruit are present with the compound. In the present disclosure, the terms “exposing”, “administering” and “contacting” and variations thereof may, in some contexts, be used interchangeably. Further, reference herein to fruit exposed to a compound should be understood to include reference to indirect exposure such that the plant, roots, leaves, seed or soil may have been exposed to the compound.

Those skilled in the art will appreciate that the beneficial effects observed in crops and fruits using the compounds the subject of the invention are typically in comparison to untreated crops and fruit. Such untreated crops and fruit may or may not be exposed to a treatment regime alternative to that the subject of the invention.

Surprisingly, as described and exemplified herein it has been found that exposing fruit to spirotetramat while the fruit is still on the plant, vine, or tree induces ripeness. The ripened fruit has the organoleptically pleasing characteristics of fruit that has fully ripened on the plant, tree, or vine, but may be removed in a shorter time frame when compared to untreated fruit. This unexpected and surprising ripeness effect in fruit is in addition to the insecticidal or miticidal effects exhibited by this compound.

MOVENTO® is a tetramic insecticide comprising spirotetramat as the active ingredient, that is presently used for the control of sucking pests including silverleaf whitefly and various aphid, scale, and thrips pests in a range of vegetable crops, pome fruit, stone fruit, citrus, mangoes, and cotton. MOVENTO® has a 2-way systemicity that distributes the active ingredient through the plant both upwards and downwards. This systemicity allows MOVENTO® to better control sucking pests also on the new growth which typical foliar spraying insecticides often do not reach.

Further compounds include spiromesifen and spirodiclofen, the active ingredients in the insecticides OBERON® and ENVIDOR® respectively. OBERON® and ENVIDOR® are used for control of mites in all life stages among others. The structures of spirotetramat, spiromesifen and spirodiclofen are as follows:

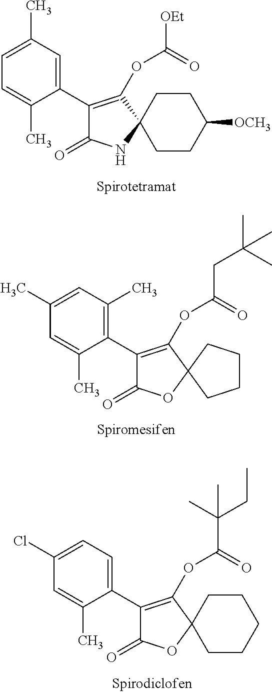 [SMILES: CCOC(=O)OC1=C(c2cc(C)ccc2C)C(=O)N[C@]12CC[C@@H](OC)CC2 ; Cc1cc(C)c(C2=C(OC(=O)CC(C)(C)C)C3(CCCC3)OC2=O)c(C)c1 ; CCC(C)(C)C(=O)OC1=C(c2ccc(Cl)cc2C)C(=O)OC12CCCCC2]

In broad terms, the present invention is directed to methods for inducing ripeness, reducing ripening time of fruit, increasing the palatability of fruit, improving desirable characteristics of fruit, and/or improving organoleptic properties of fruit.

More specifically, compounds for use in the present invention are of formula I

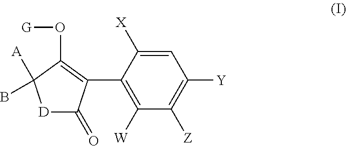

in which
X is selected from halogen, alkyl, alkoxy, haloalkyl, haloalkoxy, or cyano,
W, Y and Z independently of one another are selected from hydrogen, halogen, alkyl, alkoxy, haloalkyl, haloalkoxy, or cyano,
A is selected from hydrogen, alkyl, alkoxyalkyl, optionally substituted cycloalkyl, or optionally substituted heterocycloalkyl, wherein said alkyl and alkoxyalkyl are optionally substituted by halogen,
B is selected from hydrogen or alkyl,
or
A and B together with the carbon atom to which they are attached form a saturated or unsaturated, optionally substituted carbocyclic ring or form a saturated or unsaturated, optionally substituted heterocyclic ring,
D is selected from NH or oxygen,
G is hydrogen (a) or is selected from one of (b) to (g)

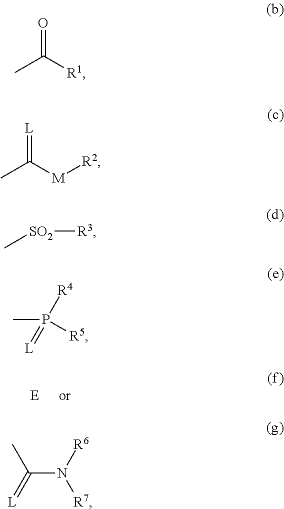

in which
E is selected from a metal ion or an ammonium ion,
L is selected from oxygen or sulphur,
M is selected from oxygen or sulphur,
R¹ is selected from alkyl, alkenyl, alkoxyalkyl, alkylthioalkyl, polyalkoxyalkyl, cycloalkyl, heterocycloalkyl, optionally substituted phenyl, optionally substituted phenylalkyl, optionally substituted hetaryl, optionally substituted phenoxyalkyl, or optionally substituted hetaryloxyalkyl, wherein said alkyl, alkenyl, alkoxyalkyl, alkylthioalkyl, and polyalkoxyalkyl are optionally substituted by halogen and said cycloalkyl and heterocycloalkyl are optionally substituted by halogen-alkyl or halogen-alkoxy,
R² is selected from alkyl, alkenyl, alkoxyalkyl, polyalkoxyalkyl, optionally substituted cycloalkyl, optionally substituted phenyl, or optionally substituted benzyl, wherein said alkyl, alkenyl, alkoxyalkyl, and polyalkoxyalkyl are optionally substituted by halogen,
R³ is selected from alkyl optionally substituted by halogen or optionally substituted phenyl,
R⁴ and R⁵ independently of one another are selected from alkyl, alkoxy, alkylamino, dialkylamino, alkylthio, alkenylthio, cycloalkylthio, optionally substituted phenyl, optionally substituted benzyl, optionally substituted phenoxy, or optionally substituted phenylthio, wherein said alkyl, alkoxy, alkylamino, dialkylamino, alkylthio, alkenylthio, and cycloalkylthio are optionally substituted by halogen, and
R⁶ and R⁷ independently of one another are selected from hydrogen, alkyl, cycloalkyl, alkenyl, alkoxy, alkoxyalkyl, optionally substituted phenyl, or optionally substituted benzyl, or together with the nitrogen atom to which they are attached form an optionally saturated or unsaturated, optionally substituted heterocyclic ring, wherein said alkyl, cycloalkyl, alkenyl, alkoxy, and alkoxyalkyl are optionally substituted by halogen,
   or an isomer mixture, pure isomer, or salt thereof, optionally in combination with one or more of a carrier, adjuvant, auxiliary, or extender.

In one embodiment, in the compound of formula I the radicals may have the following meanings:
W is selected from hydrogen, C₁-C₄-alkyl, C₁-C₄-alkoxy, chlorine, bromine, or fluorine,
X is selected from C₁-C₄-alkyl, C₁-C₄-alkoxy, C₁-C₄-haloalkyl, fluorine, chlorine, or bromine,
Y and Z independently of one another are selected from hydrogen, C₁-C₄-alkyl, halogen, C₁-C₄-alkoxy, or C₁-C₄-haloalkyl,
A is selected from hydrogen or C₁-C₆-alkyl or C₃-C₈-cycloalkyl, which are each optionally substituted by halogen,
B is selected from hydrogen, methyl, or ethyl, or
A, B and the carbon atom to which they are attached form a saturated C₃-C₆-cycloalkyl or C₃-C₆-heterocycloalkyl which contains one heteroatom selected from oxygen or sulphur, wherein said C₃-C₆-cycloalkyl or C₃-C₆-heterocycloalkyl are optionally substituted by one or two C₁-C₄-alkyl, or C₁-C₄-alkoxy groups,
D is selected from NH or oxygen,
G is hydrogen (a) or is selected from one of the groups (b) to (g)

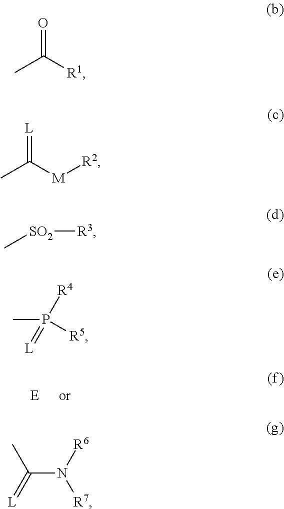

in which
E is selected from a metal ion or an ammonium ion,
L is selected from oxygen or sulphur,
M is selected from oxygen or sulphur,
R¹ is selected from C₁-C₁₀-alkyl, C₂-C₁₀-alkenyl, C₁-C₄-alkoxy-C₁-C₄-alkyl, C₁-C₄-alkylthio-C₁-C₄-alkyl, C₃-C₆-cycloalkyl, phenyl, pyridyl, or thienyl, wherein said C₁-C₁₀-alkyl, C₂-C₁₀-alkenyl, C₁-C₄-alkoxy-C₁-C₄-alkyl, and C₁-C₄-alkylthio-C₁-C₄-alkyl are optionally substituted by halogen, said C₃-C₆-cycloalkyl is optionally substituted by fluorine, chlorine, C₁-C₄-alkyl, or C₁-C₂-alkoxy, said phenyl is optionally substituted by fluorine, chlorine, bromine, cyano, nitro, C₁-C₄-alkyl, C₁-C₄-alkoxy, trifluoromethyl, or trifluoromethoxy, and said pyridyl and thienyl are optionally substituted by chlorine or methyl,
R² is selected from C₁-C₁₀-alkyl, C₂-C₁₀-alkenyl, C₁-C₄-alkoxy-C₂-C₄-alkyl, C₅-C₆-cycloalkyl, phenyl, or benzyl, wherein said C₁-C₁₀-alkyl, C₂-C₁₀-alkenyl, and C₁-C₄-alkoxy-C₂-C₄-alkyl are optionally substituted by fluorine or chlorine, said C₅-C₆-cycloalkyl is optionally substituted by methyl or methoxy, and said phenyl and benzyl are optionally substituted by fluorine, chlorine, bromine, cyano, nitro, C₁-C₄-alkyl, C₁-C₄-alkoxy, trifluoromethyl, or trifluoromethoxy,
R³ is selected from C₁-C₄-alkyl or phenyl, wherein said C₁-C₄-alkyl is optionally substituted by fluorine and said phenyl is optionally substituted by fluorine, chlorine, bromine, C₁-C₄-alkyl, C₁-C₄-alkoxy, trifluoromethyl, trifluoromethoxy, cyano, or nitro,
R⁴ is selected from C₁-C₄-alkyl, C₁-C₄-alkoxy, C₁-C₄-alkylamino, C₁-C₄-alkylthio, phenyl, phenoxy, or phenylthio, wherein said C₁-C₄-alkyl, C₁-C₄-alkoxy, C₁-C₄-alkylamino, and C₁-C₄-alkylthio are optionally substituted by fluorine or chlorine and said phenyl, phenoxy, and phenylthio are optionally substituted by fluorine, chlorine, bromine, nitro, cyano, C₁-C₄-alkoxy, trifluoromethoxy, C₁-C₄-alkylthio, C₁-C₄-haloalkylthio, C₁-C₄-alkyl, or trifluoromethyl,
R⁵ is selected from C₁-C₄-alkoxy or C₁-C₄-thioalkyl,
R⁶ is selected from C₁-C₆-alkyl, C₃-C₆-cycloalkyl, C₁-C₆-alkoxy, C₃-C₆-alkenyl, or C₁-C₄-alkoxy-C₁-C₄-alkyl,
R⁷ is selected from C₁-C₆-alkyl, C₃-C₆-alkenyl, or C₁-C₄-alkoxy-C₁-C₄-alkyl, or
R⁶ and R⁷ together with the nitrogen to which they are attached form a C₃-C₆-heterocycloalkylene group which optionally has one carbon atom replaced by oxygen or sulphur, wherein said C₃-C₆-heterocycloalkylene group is optionally substituted by methyl or ethyl, or an isomer mixture, pure isomer, or salt thereof.

In an embodiment, in the compound of formula I the radicals may have the following meaning:
G is hydrogen (a) or is selected from one of the groups (b), (c), (f), or (g)

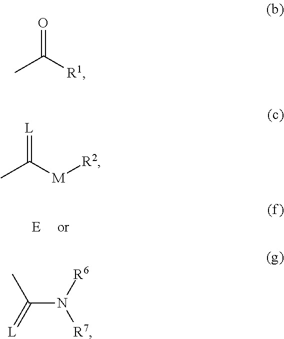

in which
E is selected from a metal ion or an ammonium ion,
L is selected from oxygen or sulphur,
M is selected from oxygen or sulphur,
R¹ is selected from C₁-C₁₀-alkyl, C₂-C₁₀-alkenyl, C₁-C₄-alkoxy-C₁-C₄-alkyl, C₁-C₄-alkylthio-C₁-C₄-alkyl, C₃-C₆-cycloalkyl, phenyl, pyridyl, or thienyl, wherein said C₁-C₁₀-alkyl, C₂-C₁₀-alkenyl, C₁-C₄-alkoxy-C₁-C₄-alkyl, and C₁-C₄-alkylthio-C₁-C₄-alkyl are optionally substituted by halogen, said C₃-C₆-cycloalkyl is optionally substituted by fluorine, chlorine, C₁-C₄-alkyl, or C₁-C₂-alkoxy, said phenyl is optionally substituted by fluorine, chlorine, bromine, cyano, nitro, C₁-C₄-alkyl, C₁-C₄-alkoxy, trifluoromethyl, or trifluoromethoxy, and said pyridyl or thienyl are optionally substituted by chlorine or methyl,
R² is selected C₁-C₁₀-alkyl, C₂-C₁₀-alkenyl, C₁-C₄-alkoxy-C₂-C₄-alkyl, C₅-C₆-cycloalkyl, phenyl or benzyl, wherein said C₁-C₁₀-alkyl, C₂-C₁₀-alkenyl, and C₁-C₄-alkoxy-C₂-C₄-alkyl are optionally substituted by fluorine or chlorine, said C₅-C₆-cycloalkyl is optionally substituted by methyl or methoxy, and said phenyl and benzyl are optionally substituted by fluorine, chlorine, bromine, cyano, nitro, C₁-C₄-alkyl, C₁-C₄-alkoxy, trifluoromethyl, or trifluoromethoxy,
R⁶ is selected from C₁-C₆-alkyl, C₃-C₆-cycloalkyl, C₁-C₆-alkoxy, C₃-C₆-alkenyl, or C₁-C₄-alkoxy-C₁-C₄-alkyl, and
R⁷ is selected from C₁-C₆-alkyl, C₃-C₆-alkenyl, or C₁-C₄-alkoxy-C₁-C₄-alkyl,
   or an isomer mixture, pure isomer, or salt thereof.

In an embodiment, in the compound of formula I the radicals may have the following meaning:
W is selected from hydrogen, methyl, ethyl, chlorine, bromine, or methoxy,
X is selected from chlorine, bromine, methyl, ethyl, propyl, isopropyl, methoxy, ethoxy, or trifluoromethyl,
Y and Z independently of one another are selected from hydrogen, fluorine, chlorine, bromine, methyl, ethyl, propyl, isopropyl, trifluoromethyl, or methoxy,
A is selected from methyl, ethyl, propyl, isopropyl, butyl, isobutyl, sec-butyl, tert-butyl, cyclopropyl, cyclopentyl, or cyclohexyl,
B is selected from hydrogen, methyl, or ethyl,
or
A, B and the carbon atom to which they are attached form a saturated C₅-C₆-cycloalkyl or C₅-C₆-heterocycloalkyl which has one ring member replaced by oxygen, wherein said C₅-C₆-cycloalkyl and C₅-C₆-heterocycloalkyl are optionally monosubstituted by methyl, ethyl, methoxy, ethoxy, propoxy, or butoxy,
D is selected from NH or oxygen,
G is hydrogen (a) or is selected from one of the groups (b), (c), (f), or (g)

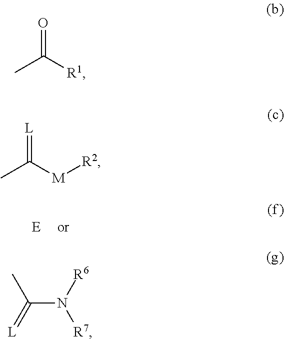

in which
E is selected from a metal ion or an ammonium ion,
M is selected from oxygen or sulphur,
R¹ is selected from C₁-C₈-alkyl, C₂-C₄-alkenyl, methoxymethyl, ethoxymethyl, ethylthiomethyl, cyclopropyl, cyclopentyl, cyclohexyl, phenyl, pyridyl, or thienyl, wherein said phenyl is optionally mono- or disubstituted by fluorine, chlorine, bromine, cyano, nitro, methyl, ethyl, methoxy, trifluoromethyl, or trifluoromethoxy and said pyridyl and thienyl are optionally substituted by chlorine or methyl,
R² is selected from C₁-C₈-alkyl, C₂-C₄-alkenyl, methoxyethyl, ethoxyethyl, phenyl, or benzyl,
R⁶ and R⁷ independently of one another are selected from methyl, ethyl, or together with the nitrogen to which they are attached from a C₅-heteroalkylene radical in which the C₃-methylene group has been replaced by an oxygen,
   or an isomer mixture, pure isomer, or salt thereof.

In an embodiment, in the compound of formula I the radicals have the following meaning:
W is selected from hydrogen or methyl,
X is selected from chlorine, bromine, or methyl,
Y and Z independently of one another are selected from hydrogen, chlorine, bromine, or methyl,
A, B and the carbon atom to which they are attached form a C₅-C₆-cycloalkyl or C₅-C₆-heterocycloalkyl which has one ring member replaced by oxygen, wherein said C₅-C₆-cycloalkyl and C₅-C₆-heterocycloalkyl are optionally monosubstituted by methyl, methoxy, ethoxy, propoxy, or butoxy,
D is selected from NH or oxygen,
G is hydrogen (a) or is selected from one of the groups (b), (c), or (g)

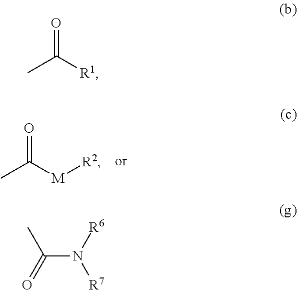

in which
M is selected from oxygen or sulphur,
R¹ is selected from C₁-C₈-alkyl, C₂-C₄-alkenyl, methoxymethyl, ethoxymethyl, ethylthiomethyl, cyclopropyl, cyclopentyl, cyclohexyl, phenyl, pyridyl, or thienyl, wherein said phenyl is optionally monosubstituted by fluorine, chlorine, bromine, methyl, methoxy, trifluoromethyl, trifluoromethoxy, cyano, or nitro and said pyridyl and theinyl are optionally substituted by chlorine or methyl,
R² is selected from C₁-C₈-alkyl, C₂-C₄-alkenyl, methoxyethyl, ethoxyethyl, phenyl, or benzyl,
R⁶ and R⁷ independently of one another is selected from methyl, ethyl, or together with the nitrogen to which they are attached form a C₅-heteroalkylene radical in which the C₃-methylene group has been replaced by an oxygen,
   or an isomer mixture, pure isomer, or salt thereof.

In particular aspects, the present invention relates to a method of inducing ripeness in a fruit or for reducing the ripening time of a fruit, the method comprising exposing a plant from which the fruit grows, the fruit, roots of the plant, leaves of the plant, seed of the plant, or soil or substrate in which the plant grows or is to be grown, to a compound of formula I as defined above, optionally in combination with one or more of a carrier, adjuvant, auxiliary, or extender.

In some exemplary embodiments, ripeness or reduced ripening time may be defined as a number of days taken for a fruit to ripen following treatment in accordance with the present invention less than the average time taken for untreated fruit to ripen on the plant, tree, or vine so that it is ready to harvest. An average time taken for a particular fruit to ripen on the plant, tree, or vine would be known to a person skilled in the art. Those skilled in the art will appreciate that the average time is dependent on numerous factors such as the growth conditions and the environment in which the plant producing the fruit is grown and also on the particular variety of the fruit. Such information would be known to a person skilled in the art or could be obtained without undue experimentation. In an exemplary embodiment, fruit exposed to a compound of formula I may ripen at least about 1 day less than an average time taken for untreated fruit to ripen on the plant, tree, or vine, optionally less than about 2, 3, 4, 5, 6, 7, 8, 9, 10, 11, 12, 13, 14, 15, 16, 17, 18, 19, 20, 21, 22, 23, 24, 25, 26, 27, 28, 29, or less than about 30 days less.

The number of days less than the average time taken for fruit exposed to a compound of formula I to ripen on the plant, tree, or vine so that it is ready to harvest may also be expressed as a percentage, such as about 1%, 2%, 3%, or 4% less time. In an exemplary embodiment, fruit exposed to a compound of formula I may be harvested at least about 1% earlier than an average time taken for untreated fruit to ripen on the plant, tree, or vine, optionally at least about 2, 3, 4, 5, 6, 7, 8, 9, 10, 11, 12, 13, 14, 15, 16, 17, 18, 19, or at least about 20% earlier.

Ripeness may also be defined as a reduced time between the plant, tree, or vine flowering and harvesting the fruit after it has been exposed to a compound of formula I. The average time taken for a particular plant, tree, or vine to flower and then fruit would be known to a person skilled in the art. Those skilled in the art will appreciate that the average time is dependent on numerous factors such as the growth conditions and the environment in which the plant producing the fruit is grown and also on the particular variety of the fruit. Such information would be known to a person skilled in the art or could be obtained without undue experimentation. In an embodiment, the average time between flowering and harvesting the fruit exposed to a compound of formula I is reduced by at least about 1 day, optionally at least about 2, 3, 4, 5, 6, 7, 8, 9, 10, 11, 12, 13, 14, 15, 16, 17, 18, 19, 20, 21, 22, 23, 24, 25, 26, 27, 28, 29, or at least about 30 days. Ripeness may also be defined as a reduced time between the plant, tree, or vine flowering and harvesting the fruit, which may also be expressed as a percentage, such as about 1%, 2%, 3%, or 4% less time. In an exemplary embodiment, the time between flowering and harvesting the fruit exposed to a compound of formula I may be at least about 1% earlier than an average time taken between flowering and harvesting when compared to untreated fruit, optionally at least about 2, 3, 4, 5, 6, 7, 8, 9, 10, 11, 12, 13, 14, 15, 16, 17, 18, 19, or at least about 20% earlier.

The present invention also relates to methods of increasing the palatability of a fruit, to methods of improving the desirable characteristics of fruit, such as but not limited to colour, quality, size, uniformity of size and/or appearance and taste, and to methods of improving the organoleptic properties of fruit, comprising exposing a plant from which the fruit grows, the fruit, roots of the plant, leaves of the plant, seed of the plant, or soil or substrate in which the plant grows or is to be grown to a compound of formula I as defined in the first aspect, optionally in combination with one or more of a carrier, adjuvant, auxiliary, or extender.

The palatability, organoleptic properties, and desirable characteristics of fruit may be measured, for example, by the amount of sugar present in the fruit, which is expressed as a percentage total soluble solids (TSS) in the fruit. For example, fruit exposed to a compound of formula I may demonstrate an increase in TSS when compared to untreated fruit. The TSS of fruit may also be expressed in degrees Brix. Degrees Brix (°Bx) is the sugar content of an aqueous solution. One degree Brix is 1 gram of sucrose in 100 grams of solution and represents the strength of the solution as a percentage by weight (% w/w). Brix may be measured using a refractometer. The determination of the particular degrees Brix of fruit is routine and appropriate methods for such a determination are known to those of skill in the art.

In an exemplary embodiment, fruit exposed to a compound of formula I may have a TSS content at least about 1% higher than the TSS of untreated fruit, at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 35 or at least about 40% higher than the TSS of untreated fruit. In an embodiment, the TSS may be between about 4% to about 20% higher, optionally about 5% to about 15% higher than the TSS of untreated fruit.

The palatability, organoleptic properties, and desirable characteristics of fruit may also be measured by the titratable acidity (TA) of the fruit, which is expressed as the amount of base, such as NaOH, required to neutralise the acid in the fruit. Typically, the TA is expressed in mmol of base and may be determined using standard titration techniques or the use of automatic titration machines. The determination of the particular TA of fruit is routine and appropriate methods for such a determination are known to those of skill in the art.

In an exemplary embodiment, fruit exposed to a compound of formula I may have a TA content at least about 1% higher than the TA of untreated fruit, at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, or at least about 40% higher than the TA of untreated fruit. In an embodiment, the TA may be between about 4% to about 20% higher, optionally about 5% to about 15% higher than the TA of untreated fruit.

The organoleptic properties and desirable characteristics of fruit may also be measured by the colour of the fruit, typically the darkness of the fruit. Generally speaking, the darker the fruit the more ripe the fruit. As the fruit ripens, the amount of colour causing compounds, for example anthocyanins, increase in the skin of the fruit leading to a darker colour. For some fruits, such as grapes and plums, darker coloured skin is perceived as being riper and more desirable by consumers.

Colour can be defined using a number of different systems, including for example the RGB and Lab systems.

### RGB

The human eye senses colour using a series of photoreceptors (cone cells) with sensitivity peaks in short (S, 420-440 nm), middle (M, 530-540 nm), and long (L, 560-580 nm) wavelengths. These approximately correspond to blue, green and red colours, although there are overlaps between the sensitivities of each. All the colours that we see are combinations of the responses of these three types of cone cells to various wavelengths. The measurement of RGB values can be made using a chroma-meter, such as a Minolta chroma-meter (CR-400), although any means of measuring colour may be used, such as using digital photographic methods.

### Lab

The 1948 Hunter Lab colour space defines colour in terms of L-value, corresponding to lightness or brightness, +a to −a corresponding to red to green and +b to −b corresponding to yellow to blue. The Lab model is a non-linear coding system for colour that is supposed to align closely with human perceptions. In 1976 the model was somewhat superseded by the CIE scale, usually referred to as L*a*b* or CIELAB. Although the two scales are very similar, the L*a*b* uses a cube root transformation of the data whereas the Hunter system uses a square root. The L value is a number out of 100, such that 100 is fully white and 0 is flat black. Values of a and b are not set, but depend on the conversion method—it seems they are primarily relative to each other, rather than fixed. Values for a and b can be integrated by calculating the Hue angle. Hue angle indicates the position of the combination of a and b on the CIE colour wheel. For example, if b=0 and a=10, then Hue angle is zero, while if b=0 and a=−10, Hue angle is 180.

In accordance with the present invention, colour of fruit may be measured using a chroma-meter, such as a Minolta chroma-meter (CR-400), although any means of measuring colour may be used, such as using digital photographic methods. Different methods of measuring colour are known to those of skill in the art and can be used to determine the fruit colour for the purposes of the present invention. Data from the chroma-meta or photographs may used to obtain L*, a*, and b* readings, and Hue angle and chroma may be calculated from these readings. A person skilled in the art is well accustomed to performing such calculations and can perform them routinely or with the aid of computers and software. It is better to use the average colour of a group of individual pieces of fruit from across the plant, tree, or vine, rather than selecting individual pieces of fruit. This ensures an accurate colour reading of the fruit across the plant, tree, or vine.

Values for L*, a* and b* can all be used to discriminate between the colour changes of fruit as it ripens, for example green to red or green to purple. These values change in a relatively consistent and linear manner as fruit ripens.

Generally speaking, lower Hue values, lower L* values, lower a* values, and/or lower b* values are representative of fruit that is darker in colour. Fruit that is darker is more desirable and organoleptically pleasing to consumers and is perceived as being “more ripe”.

In an exemplary embodiment, the average Hue value of fruit exposed to a compound of formula I may be at least about 1% lower than the Hue value of untreated fruit, optionally at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, or at least about 40% lower than the Hue value of untreated fruit. In an embodiment, the average Hue value may be between about 7% to about 25% lower, optionally about 10% to about 20% lower than the Hue value of untreated fruit.

In an exemplary embodiment, the average L* value of fruit exposed to a compound of formula I may be at least about 1% lower than the L* value of untreated fruit, optionally at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, or at least about 40% lower than the L* value of untreated fruit. In an embodiment, the average L* value may be between about 5% to about 20% lower, optionally about 7% to about 15% lower than the L* value of untreated fruit.

In an exemplary embodiment, the average a* value of fruit exposed to a compound of formula I may be at least about 1% lower than the a* value of untreated fruit, at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, or at least about 40% lower than the a* value of untreated fruit. In an embodiment, the average a* value may be between about 1% to about 20% lower, optionally about 1% to about 15% lower than the a* value of untreated fruit.

In an exemplary embodiment, the average b* value of fruit exposed to a compound of formula I may be at least about 1% lower than the b* value of untreated fruit, at least about 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, or at least about 40% lower than the b* value of untreated fruit. In an embodiment, the average b* value may be between about 5% to about 20% lower, optionally about 7% to about 15% lower than the b* value of untreated fruit.

Juice of fruit treated with a compound of formula I may also be of a darker colour when compared to juice of untreated fruit. For an appropriate comparison, the fruit may be blended and filtered. The filtered juice may then be centrifuged to remove any particulates and the supernatant juice may be removed for comparison. Removing the skin and particulates removes colour causing compounds that are present in the skin, such as anthocyanins, which can influence any colour analysis of the juice. In an embodiment, the fruit juice obtained from fruit treated with a compound of formula I may have an average Hue, L*, a*, and/or b* value that is about 1% to about 40% lower than the average Hue, L*, a*, and/or b* values of fruit juice obtained from fruit that has not been exposed to a compound of formula I. In an embodiment, the average Hue value is between about 7% to about 30% lower and the average L* value is between about 7% to about 25% lower.

By way of non-limiting example only, fruits applicable to treatment in accordance with the present invention include citrus, pome or stone fruits, berries and grapes. The citrus fruit may be, for example, oranges, limes, lemons, grapefruit, mandarins, tangerines, tangelos and the like. The pome fruit may be, for example, apples or pears. The stone fruit may be, for example, plums, peaches, apricots or nectarines. The berries may be, for example, blueberries, raspberries, strawberries or blackberries. In particular embodiments the fruit are grapes. The grapes may be table grapes or wine grapes.

Embodiments of the present invention contemplate the administration of compounds of formula I together with one or more further agriculturally acceptable compounds, such as pesticides, insecticides, fungicides, herbicides, fertilisers, hormones, growth agents, and the like. The one or more further agriculturally acceptable compounds employed may be selected for the particular application of the invention on a case-by-case basis, and those skilled in the art will appreciate that the scope of the present invention is not limited by the nature or identity of the particular one or more further agriculturally acceptable compounds.

In accordance with the present invention, the application of a compound of formula I and one or more further agriculturally acceptable compounds can be at the same time or at different times, i.e. application can be simultaneous or sequential. Furthermore, the compound and the one or more further agriculturally acceptable compounds can be co-formulated or formulated in separate compositions. In instances where the compounds are formulated in different compositions, they can be applied or delivered by the same or different routes or means. For example, when a plant and/or fruit is exposed to a compound of formula I and one or more further agriculturally acceptable compounds in accordance with the invention, the compounds can be co-formulated in the same composition or formulated in different compositions and applied by the same route or different routes, e.g. by granules, spraying, misting, dripping application, and the like, simultaneously or sequentially.

The compound of formula I may be applied to the fruit, seed, plant, or soil using any means known in the art. Such administration methods include spraying (by hand, mechanical, aerial, automatic, or other means), drip application, chemigation, or other application means known to those of skill in the art.

According to the invention, exposure of a seed of a plant from which the fruit grows, the plant, the roots of the plant, the leaves of the plant, the fruit, or to soil in which the plant grows or is to be grown with the active compound is carried out directly or by action on their environment, habitat or storage area according to customary treatment methods, for example by dipping, spraying, evaporating, atomizing, broadcasting, brushing-on, injection and, in the case of propagation material, in particular in the case of seeds, furthermore by one- or multi-layer coating.

In an embodiment, the compound for use in the present invention is applied directly to the seed of a plant from which the fruit grows, the plant, the roots of the plant, the leaves of the plant, the fruit, or to soil in which the plant grows or is to be grown, optionally directly onto the plant, optionally directly onto the leaves of the plant. In an embodiment, the compound for use in the present invention is sprayed onto the plant, optionally by foliar spraying.

In an embodiment, the compound for use in the present invention may be applied at least once. Optionally the compound may be applied more than once, such as, for example 2, 3, 4, 5, 6, 7, 8, 9, 10, 11, 12, 13, 14, 15 or more times.

Where the compound to be applied has pesticidal, for example insecticidal activity, such as spirotetramat, spiromesifen and spirodiclofen, the amount of the compound to be applied may be less than an amount required to treat pests in the fruit and/or plant, may be equal to an amount required to treat pests in the fruit and/or plant, or may be an amount greater than an amount required to treat pests in the fruit and/or plant.

In an exemplary embodiment, the amount of the compound of formula I for use in the invention may be at least about 50 g/Ha, optionally about 75, 100, 125, 150, 200, 250, 400, or at least about 500 g/Ha. In an embodiment, the amount of the compound of formula I for use in the invention may be about 50 g/Ha to about 500 g/Ha, optionally about 75 to 500, 100 to 500, 125 to 500, 150 to 500, 200 to 500, 250 to 500, or about 400 g/Ha to about 500 g/Ha. In an embodiment, the amount of the compound of formula I for use in the invention may be about 50 g/Ha to about 500 g/Ha, optionally about 50 to 400, 50 to 250, 50 to 200, 50 to 150, 50 to 125, 50 to 100, or about 50 g/Ha to about 75 g/Ha.

In an exemplary embodiment, the amount of the compound of formula I for use in the invention may be at least about 70 ppm, optionally about 80, 90, 100, 110, 120, 130, 140, 150, or at least about 160 ppm, optionally at least about 70, 90, 110, or 130 ppm. In an embodiment, the amount of the compound of formula I for use in the invention may be about 60 to about 160 ppm, optionally about 70 to 150, 80 to 140, 90 to 130, 100 to 120, or about 100 to about 110 ppm, optionally about 70 to about 130, or about 90 to about 110 ppm. In an embodiment, the amount of the compound of formula I for use in the invention may be about 70 to about 160 ppm, optionally about 70 to 150, 70 to 140, 70 to 130, 70 to 120, 70 to 110, 70 to 100, 70 to 90, or about 70 to 80 ppm, optionally about 70 to 90 ppm or about 80 to 110 ppm.

In an exemplary embodiment, the amount of the compound of formula I for use in the invention may be at least about 25 mL/100 L, optionally about 30, 35, 40, 45, 50, 55, 60, 65, or at least about 70 mL/100 L, optionally at least about 30, 40, 50, or 60 mL/100 L. In an embodiment, the amount of the compound of formula I for use in the invention may be about 25 to about 70 mL/100 L, optionally about 30 to 65, 35 to 60, 40 to 55, or about 45 to about 50 mL/100 L, optionally about 30 to about 60, or about 40 to about 50 mL/100 L. In an embodiment, the amount of the compound of formula I for use in the invention may be about 30 to about 70 mL/100 L, optionally about 30 to 65, 30 to 60, 30 to 55, 30 to 50, 30 to 45, or about 30 to 40 mL/100 L, optionally about 30 to 40 mL/100 L or about 30 to 50 mL/100 L.

In an exemplary embodiment, the amount of the compound of formula I for use in the invention may be at least about 6.0 g ai/100 L (grams active per 100 litres), optionally about 7.2, 8.4, 9.6, 10.8, 12.0, 13.2, 14.4, 15.6, or at least about 16.8 g ai/100 L, optionally at least about 7.2, 9.6, 12.0, or 14.4 g ai/100 L. In an embodiment, the amount of the compound of formula I for use in the invention may be about 6.0 to about 16.8 g ai/100 L, optionally about 7.2 to 15.6, 8.4 to 14.4, 9.6 to 13.2, or about 10.8 to about 12.0 g ai/100 L, optionally about 7.2 to about 14.4, or about 9.6 to about 12.0 g ai/100 L. In an embodiment, the amount of the compound of formula I for use in the invention may be about 7.2 to about 16.8 g ai/100 L, optionally about 7.2 to 15.6, 7.2 to 14.4, 7.2 to 13.2, 7.2 to 12.0, 7.2 to 10.8, or about 7.2 to 9.6 g ai/100 L, optionally about 7.2 to 9.6 g ai/100 L or about 7.2 to 12.0 g ai/100 L.

Formulations for use in the invention which comprise a compound of formula I may be in any customary form suitable for application, such as solutions, emulsions, wettable powders, water- and oil-based suspensions, powders, dusts, pastes, soluble powders, soluble granules, granules for broadcasting, suspension-emulsion concentrates, natural materials impregnated with active compound, synthetic materials impregnated with active compound, fertilizers and microencapsulations in polymeric substances.

These formulations are produced in a known manner, for example by mixing the active compounds with suitable adjuvants, extenders, that is liquid solvents and/or solid carriers, optionally with the use of surfactants, that is emulsifiers and/or dispersants and/or foam-formers. The formulations are prepared either in suitable plants or else before or during the application.

The compound of formula I for use in the present invention may be used in conjunction with an adjuvant, which aids absorption of the compound into the desired plant and/or fruit. Suitable adjuvants include inorganic or organic chemicals and macromolecules, or any mixtures thereof. In particular embodiments of the present invention, the adjuvant may predominantly consist of methyl or ethyl esters (or mixtures thereof) of fatty acids originating from plant oils, optionally the plant oils may be selected from sunflower oil, canola oil, rapeseed oil, soybean oil, corn oil or like. By way of example, suitable adjuvants for use in the present invention include HASTEN®, KWICKEN®, UPTAKE®, ROCKET®, AUREO®, STEFES MERO®, DYNE-AMIC®, BIOPEST®, AGRIDEX® and ZAP®. In another embodiment of the present invention, the adjuvant may be from the class of polyalkoxylated triglycerides that may be described by CAS 70377-91-2 or CAS 165658-61-7 and that are commercially available, optionally under the brand names Crovol A 70 UK®, Crovol CR 70 G®, Crovol M 70® and Crovol PK 70® from Croda and Radia 6107® from Oleon. In an embodiment, the adjuvant may be selected from a class of C₈-C₁₀ polyethoxylated fatty alcohols. By way of example, suitable adjuvants may be selected from the class of polyethoxylated alcohols that may be described by CAS 9043-30-5 (GENAPOL X080) or 27213-90-7 (GENAPOL C₁₀₀) and that are commercially available, optionally under the brand name(s) Genapol X® and Genapol C®, respectively. In another embodiment of the present invention, the adjuvant may be selected from a class of C₈-C₁₀ polyalkoxylated fatty alcohols. By way of example, suitable adjuvants may be selected from the class of polypropoxylated-ethoxylated alcohols that may be described by CAS 64366-70-7 and that is commercially available, optionally under the brand name Tanemul HOT.

Suitable auxiliaries for use in the present invention include substances that are suitable for imparting to the composition itself and/or to preparations derived therefrom (for example spray liquors, seed dressings) particular properties such as certain technical properties and/or also particular biological properties. Typical suitable auxiliaries are: extenders, solvents and carriers.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide). In an embodiment, the extender may be a non-ionic-extender-sticker-spreader. Such an extender reduces run-off at application, i.e. when sprayed, and helps sprayed compounds penetrate and spread out evenly across the surface of a leaf. By way of example, a suitable extender is NU-FILM® 17, which comprises di-1-p-menthene as active ingredient.

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohexanone, strongly polar solvents such as dimethylformamide and dimethyl sulphoxide, and also water.

Suitable solid carriers for use in the present invention include, for example ammonium salts and ground natural minerals, such as kaolins, clays, talc, chalk, quartz, attapulgite, montmorillonite or diatomaceous earth, and ground synthetic minerals, such as finely divided silica, alumina and silicates; suitable solid carriers for granules are: for example crushed and fractionated natural rocks, such as calcite, marble, pumice, sepiolite and dolomite, and also synthetic granules of inorganic and organic meals, and granules of organic material, such as paper, sawdust, coconut shells, maize cobs and tobacco stalks, suitable emulsifiers and/or foam-formers are: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol/POE and/or POP ethers, acid and/or POP/POE esters, alkylaryl and/or POP/POE ethers, fat and/or POP/POE adducts, POE and/or POP polyol derivatives, POE and/or POP/sorbitan or sugar adducts, alkyl or aryl sulphates, sulphonates and phosphates, or the corresponding PO ether adducts. Furthermore suitable oligo- or polymers, for example those derived from vinylic monomers, from acrylic acid, from EO and/or PO alone or in combination with, for example, (poly)alcohols or (poly)amines. It is also possible to employ lignin and its sulphonic acid derivatives, unmodified and modified celluloses, aromatic and/or aliphatic sulphonic acids and their adducts with formaldehyde.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Other features of the invention may become apparent from the following description which is given by way of example only.

### EXAMPLES

### Data Management

Data generated in this trial was managed and statistically analysed within ARM (Agriculture Research Manager), a data management package used for planning, recording, evaluation and retrieval of trial data. Any data analysed is compared using the Duncan's multiple range test with statistical differences between treatments determined at the 5% level. Data failing homogeneity was transformed using an appropriate transformation.

### Weather

Daily weather information was recorded for each example. Measurements recorded include rainfall, hours of sunshine, wind etc.

### Seasonal Conditions:

Regular irrigation maintained the plantings used in the examples at their optimum.

### Conditions at Application:

No adverse conditions were recorded at time of application; all plants were growing normally and were dry.

### Crop Development and General Comments

The sites used for the examples receive adequate pest and disease control measures. There were no unexpected differences between the trial areas and that of the remainder of the block.

### Example 1

### Treatment of Table Grapes

MOVENTO® 240 SC (240 g ai/L (active grams per litre) spirotetramat) at rates of 4.8, 7.2, 9.6, 14.4 and 19.2 g ai/100 L plus AGRIDEX® (990 g ai/L paraffin oil plus emulsifier) at 50 mL/100 L, MOVENTO® 100 SC (100 g ai/L spirotetramat) at rates of 4.8 and 19.2 g ai/100 L were applied to a commercial crop of Red Globe table grapes. Treatments were applied at inflorescence visible, 80% capfall and fruit ripening to control plague thrips (Thrips imagines). MOVENTO® treatments were compared to the commercial standard Dimethoate 400 EC (400 g/L dimethoate) (see Tables 1 to 3).

TABLE 1
Example information

| Application Code | A | | B | | C | |
|---|---|---|---|---|---|---|
| Application Date | 2 Nov. 2011 | | 18 Nov. 2011 | | 20 Jan. 2012 | |
| Interval to prev. | | | 16 | DAY | 63 | DAY |
| Appl. | | | | | | |
| Application Timing | According | | According | | According | |
| | Crop Stage | | Crop Stage | | Crop Stage | |
| Application Start | 00:00 | | 00:00 | | 00:00 | |
| Time | | | | | | |
| Time Finish | 00:00 | | 00:00 | | 00:00 | |
| Appl. Rain 0-6 H | 0 | MM | 0 | MM | 0 | MM |
| Air Temperature | 31.1° | C. | 26.5° | C. | 35° | C. |

| | | | |
|---|---|---|---|
| % Relative Humidity | 39 | 32 | 30 |
| Appl. Wind Strength | Calm | Calm | Calm |
| Wind Velocity (k/h) | 1.5 | 1.3 | 1.1 |
| Wind Direction | E | E | NE |
| Plant Condition | Normal | Normal | Normal |

Crop Stage at Application

| Application Code | A | | B | | C | |
|---|---|---|---|---|---|---|
| Crop | VITVI | | VITVI | | VITVI | |
| Stage Majority | Inflores- | | 80% of | | Beginning of | |
| | cences | | flowerhoods | | ripening | |
| | fully | | fallen | | | |
| | developed | | | | | |
| % Stage Majority | 100 | | 100 | | 100 | |
| Canopy Height | 2 | m | 2 | m | 2 | m |

| | | | |
|---|---|---|---|
| Leaf Wall Area | 11430 | 11430 | 11430 |
| (m²/ha) | | | |

Application Equipment

| Application Code | A | | B | | C | |
|---|---|---|---|---|---|---|
| Application Method | Spray | | Spray | | Spray | |
| Application | Foliar- | | Foliar- | | Foliar- | |
| Placement | Topical | | Topical | | Topical | |
| Equipment Type | Knapsack | | Knapsack | | Knapsack | |
| | sprayer, | | sprayer, | | sprayer, | |
| | motorized | | motorized | | motorized | |
| Carrier | Water | | Water | | Water | |
| Spray Volume | 571.4 | L/ha | 900 | L/ha | 900 | L/ha |
| Operating Pressure | 240 | kPa | 240 | kPa | 240 | kPa |
| Spray Swath Width | 55 | cm | 55 | cm | 55 | cm |
| Nozzle Type | Hollow Cone | | Hollow Cone | | Hollow Cone | |
| Nozzle Size | TXB8001VK | | TXB8001VK | | TXB8001VK | |
| Nozzles per Row | 2 | | 2 | | 2 | |
| Nozzle Spacing | 10 | cm | 10 | cm | 10 | cm |

TABLE 2
Compounds used in Example 1

| Entry | FL- | Ingredient | Ingredient | ai | Lot Batch |
|---|---|---|---|---|---|
| Description | Type* | Name | Amount | unit | No. |
| AGRIDEX ® | XL | adjuvant | 990 | g ai/L | PAIE000057 |
| Dimethoate | EC | dimethoate | 400 | g ai/L | NA |
| MOVENTO ® | SC | spirotetramat | 100 | g ai/L | 2011-002122 |
| MOVENTO ® | SC | spirotetramat | 240 | g ai/L | PASF000055 |

*CropLife International Formulation Codes.

TABLE 3
Spraying regime

| | | Product | Active | | |
|---|---|---|---|---|---|
| Trt. | | Dosage | Ingredients | ai Dosage | Appl. |
| No | Product | mL/100 L | (ai) | g ai/100 L | Code |
| 1 | Untreated | | untreated | | |
| 2 | MOVENTO ® | 20 | spirotetramat | 4.8 | ABC |
| | 240 SC | | | | |
| | AGRIDEX ® | 50 | adjuvant | | |
| 3 | MOVENTO ® | 30 | spirotetramat | 7.2 | ABC |
| | 240 SC | | | | |
| | AGRIDEX ® | 50 | adjuvant | | |
| 4 | MOVENTO ® | 40 | spirotetramat | 9.6 | ABC |
| | 240 SC | | | | |
| | AGRIDEX ® | 50 | adjuvant | | |
| 5 | MOVENTO ® | 60 | spirotetramat | 14.4 | ABC |
| | 240 SC | | | | |
| | AGRIDEX ® | 50 | adjuvant | | |
| 6 | MOVENTO ® | 80 | spirotetramat | 19.2 | ABC |
| | 240 SC | | | | |
| | AGRIDEX ® | 50 | adjuvant | | |
| 7 | MOVENTO ® | 48 | spirotetramat | 4.8 | ABC |
| | 100 SC | | | | |
| 8 | MOVENTO ® | 192 | spirotetramat | 19.2 | ABC |
| | 100 SC | | | | |
| 9 | Dimethoate | 75 | dimethoate | 30 | ABC |

At 20 days after application, 20 bunches per vine were assessed for thrips damage. Light populations of plague thrips were observed in both the untreated and treated Red Globe table grape crops during flowering. No thrips were observed at the start of the study, or during fruit colouring and ripening.

### Fruit Colouring

At 81 days after application (harvest) each plot was given a score on a scale of 1 to 9 (“Colour Score”) for amount of fruit colouring. A score of one being green, whilst a score of 10 was dark red. Four samples were taken from different areas of the vine for each entry and the resultant colour assessment as shown in Table 4 is the average of these colour assessments.

TABLE 4
Colour analysis

| Part Rated | | | | Fruit |
|---|---|---|---|---|
| Rating Data Typ | | | | Colour |
| Rating Unit Scale | | | | 1-9 |
| Sample Size | | | | 1 |
| Sample Size Unit | | | | Plot |
| Assessment Date | | | | 10 Apr. 2012 |
| Assessment Code | | | | A6 |
| Days after last Appl. | | | | 81 |
| Entry | Entry/Trt. | Transformed | Transformed | Colour |
| No. | Description | Dosage | Dosage Unit | Score |
| 1 | Untreated | | | 5.8 |
| 2 | MOVENTO ® | 4.8 | g ai/100 L | 6.8 |
| | 240 SC | | | |
| | AGRIDEX ® | 50 | mL/100 L | |
| 3 | MOVENTO ® | 7.2 | g ai/100 L | 7.5 |
| | 240 SC | | | |
| | AGRIDEX ® | 50 | mL/100 L | |
| 4 | MOVENTO ® | 9.6 | g ai/100 L | 7.5 |
| | 240 SC | | | |
| | AGRIDEX ® | 50 | mL/100 L | |
| 5 | MOVENTO ® | 14.4 | g ai/100 L | 8.0 |
| | 240 SC | | | |
| | AGRIDEX ® | 50 | mL/100 L | |
| 6 | MOVENTO ® | 19.2 | g ai/100 L | 7.0 |
| | 240 SC | | | |
| | AGRIDEX ® | 50 | mL/100 L | |
| 7 | MOVENTO ® | 4.8 | g ai/100 L | 5.5 |
| | 100 SC | | | |
| 8 | MOVENTO ® | 19.2 | g ai/100 L | 7.3 |
| | 100 SC | | | |
| 9 | Dimethoate | 30 | g ai/100 L | 7.3 |

| | |
|---|---|
| Standard Deviation | 1.20 |
| CV | 17.33 |
| P(Friedman's) | 0.236 |

Means followed by same letter do not significantly differ (P=0.05, Friedman's non parametric ANOVA). Mean comparisons performed only when AOV Treatment P(F) is significant at mean comparison OSL.

### Conclusion

All MOVENTO® 240 SC treatments recorded colouring scores greater than the untreated grapes.

### Example 2

### Stone Fruit

MOVENTO® 240 SC (240 g ai/L spirotetramat) at rates of 4.8, 7.2, 9.6 and 12 g ai/100 L plus HASTEN® (704 g ai/L esters of vegetable oil) at 50 mL/100 L were applied twice to a commercial crop of Tegan Blue plums to control obscure mealybug (Pseudococcus virburni). A treatment of MOVENTO® at 9.6 g ai/100 L plus AGRIDEX® (990 g ai/L paraffin oil plus emulsifier) at 50 mL/100 L was compared to MOVENTO® at 9.6 g ai/100 L plus HASTEN® at 50 mL/100 L. An initial application was made as fruit reached shuck fall and then repeated 14 days later as fruit reached half size. MOVENTO® treatments were compared to the commercial standard APPLAUD® 440 SC (440 g ai/L buprofezin) at a rate of 60 mL/100 L (see Tables 5 to 10).

TABLE 5
Spraying conditions

| | | |
|---|---|---|
| Application Code | A | B |
| Application Date | 14 Oct. 2012 | 28 Oct. 2012 |
| Interval to prev. | | 14 day |
| Appl. | | |
| Application Timing | According | According |
| | Crop Stage | Crop Stage |
| Application Start | 15:00 | 14:30 |
| Time | | |
| Air Temperature | 20.9 C. | 28.8 C. |
| % Relative Humidity | 49 | 36 |
| % Cloud Cover | 60 | 30 |
| Appl. Wind Strength | Calm | Calm |
| Wind Velocity km/h | 1.6 | 1.4 |
| Wind Direction | W | S |
| Plant Condition | Normal | Normal |

TABLE 6
Crop information

| | | |
|---|---|---|
| Application Code | A | B |
| Crop | PRNDO | PRNDO |
| Variety | Tegan Blue | Tegan Blue |
| Stage Majority | Green ovary | Fruit about half |
| | surrounded by | final size |
| | dying sepal crown | |
| % Stage Majority | 100 | 100 |
| Canopy Height | 3 m | 3 m |
| Leaf Wall Area - | 15000 | 15000 |
| m²/ha | | |

TABLE 7
Types of spraying

| | | |
|---|---|---|
| Application Code | A | B |
| Application Method | Spray | Spray |
| Application Placement | Foliar- | Foliar- |
| | Topical | Topical |
| Equipment Type | Knapsack | Knapsack |
| | sprayer, | sprayer, |
| | motorized | motorized |
| Carrier | Water | Water |

| | | | | |
|---|---|---|---|---|
| Spray Volume | 2001 | L/ha | 2001 | L/ha |
| Operating Pressure | 200 | kPa | 200 | kPa |
| Spray Swath Width | 50 | cm | 50 | cm |

| | | |
|---|---|---|
| Nozzle Type | Hollow Cone | Hollow Cone |
| Nozzle Size | TXVK-18 | TXVK-18 |
| Nozzles per Row | 2 | 2 |

| | | | | |
|---|---|---|---|---|
| Nozzle Spacing | 10 | cm | 10 | cm |

TABLE 8
Compounds used in Example 2

| Entry | FL- | Ingredient | Ingredient | ai | Lot Batch |
|---|---|---|---|---|---|
| Description | Type* | Name | Amount | unit | No. |
| AGRIDEX ® | XL | paraffin | 99 | % ai | NHB249133 |
| | | oil plus | | w/w | |
| | | emulsifier | | | |
| APPLAUD ® | SC | buprofezin | 440 | g ai/L | Yg28971100 |
| HASTEN ® | SL | vegetable | 704 | g ai/L | NA |
| | | oil, ethyl | | | |
| | | and methyl | | | |
| | | esters of | | | |
| MOVENTO ® | SC | spirotetramat | 240 | g ai/L | PASF000055 |

*CropLife International Formulation Codes.

TABLE 9
Spraying regime

| | | | Active | | |
|---|---|---|---|---|---|
| Trt. | | Product | Ingredients | ai Dosage | Appl. |
| No | Product | Dosage | (ai) | g ai/100 L | Code |
| 1 | Untreated | | untreated | | |
| 2 | MOVENTO ® | 20 mL/100 L | spirotetramat | 4.8 | AB |
| | HASTEN ® | 50 mL/100 L | vegetable oil, | | |
| | | | ethyl and | | |
| | | | methyl | | |
| | | | esters of | | |
| 3 | MOVENTO ® | 30 mL/100 L | spirotetramat | 7.2 | |
| | HASTEN ® | 50 mL/100 L | vegetable oil, | | AB |
| | | | ethyl and | | |
| | | | methyl | | |
| | | | esters of | | |
| 4 | MOVENTO ® | 40 mL/100 L | spirotetramat | 9.6 | AB |
| | HASTEN ® | 50 mL/100 L | vegetable oil, | | |
| | | | ethyl and | | |
| | | | methyl | | |
| | | | esters of | | |
| 5 | MOVENTO ® | 50 mL/100 L | spirotetramat | 12 | AB |
| | HASTEN ® | 50 mL/100 L | vegetable oil, | | |
| | | | ethyl and | | |
| | | | methyl | | |
| | | | esters of | | |
| 6 | MOVENTO ® | 40 mL/100 L | spirotetramat | 9.6 | AB |
| | HASTEN ® | 50 mL/100 L | paraffin | | |
| | | | oil plus | | |
| | | | emulsifier | | |
| 7 | APPLAUD ® | 60 mL/100 L | buprofezin | 26.4 | AB |

NB: APPLAUD ® is a non-registered standard used in this trial.

Moderate populations of obscure mealybugs (Pseudococcus virburni) were observed in both the untreated and treated Tegan Blue plum crops. The populations were insufficient to have an effect on the colouring and/or ripening of the crops.

### Colour Estimation

At 94 DAB, 15 fruit for each treatment were assessed for colouring. The area of skin for each fruit that had changed from yellow to red was estimated as a percent of the whole fruit. 10%=a small amount of the plums surface area was red, 90%=majority of the plums surface area was red.

TABLE 10
Colour readings of harvested fruit

| SE Label | | | | | Harvest | |
|---|---|---|---|---|---|---|
| Part Rated | | | | | Fruhar | |
| Criterium | | | | | Colour | |
| Assessment Type | | | | | Colour | |
| Assessment Unit | | | | | % Area Coloured | |
| Sample Size | | | | | 15 | |
| Sample Size Unit | | | | | Fruit | |
| Assessment Date | | | | | 30 Jan. 2013 | |
| Days after last Appl. | | | | | 94 DAB | |
| Entry | Entry/Trt. | Trans. | Trans. | Appl. | % Area | |
| No. | Description | Dose | Dose Unit | Code | coloured | |
| 1 | Untreated | | | | 50.4 | (b) |
| 2 | MOVENTO ® | 4.8 | g ai/100 L | AB | 59.7 | (ab) |
| | HASTEN ® | 50 | mL/100 L | AB | | |
| 3 | MOVENTO ® | 7.2 | g ai/100 L | AB | 49.0 | (b) |
| | HASTEN ® | 50 | mL/100 L | AB | | |
| 4 | MOVENTO ® | 9.6 | g ai/100 L | AB | 71.3 | (a) |
| | HASTEN ® | 50 | mL/100 L | AB | | |
| 5 | MOVENTO ® | 12 | g ai/100 L | AB | 67.8 | (a) |
| | HASTEN ® | 50 | mL/100 L | AB | | |
| 6 | MOVENTO ® | 9.6 | g ai/100 L | AB | 59.1 | (ab) |
| | AGRIDEX ® | 50 | mL/100 L | AB | | |
| 7 | APPLAUD ® | 26.4 | g ai/100 L | AB | 51.9 | (b) |

| | |
|---|---|
| Treatment Prob(F) | 0.0116 |

Means followed by same letter do not significantly differ (P=0.05, Duncan's New MRT). Mean comparisons performed only when AOV Treatment P(F) is significant at mean comparison OSL. Original means presented.

MOVENTO® at rates of 9.6 g ai/100 L plus HASTEN® and above recorded greater fruit area colouring (more red surface area) than the untreated fruit, all other treatments recorded similar red surface area to the untreated fruit.

### Example 3

### Red Globe Grapes

### General Information

Red globe grape vines were grown in Western Australia with and without treatment with MOVENTO® (Spirotetramat). Eight treated (T) and eight untreated (C) vines were located randomly along a single row. None of the untreated or treated Red globe grape crops showed any signs of thrips or mealybugs.

Grapes were harvested on 14 Mar. 2012 at normal commercial maturity. Whole bunches with total weight 8-10 kg were packed inside lined grape cartons according to commercial practice (one box/vine). Blue Uvasys SO₂ release sheets were included inside each box.

Additional grape samples from each vine were processed using a domestic juicer. The juice samples were bagged and frozen before transport with the intact fruit. Temperature data loggers were inserted into four of the cartons. The cartons were placed in a cold room to cool thoroughly before transport to Sydney via Adelaide by refrigerated truck. On arrival at the depot, they were collected and driven to the University of Western Sydney laboratory by air-conditioned vehicle.

### Sampling Method

The cartons were unpacked in the 20° C. postharvest lab and the SO₂ sheets removed. Twenty individual berries were randomly selected from each box for analysis of quality attributes. No more than three berries were taken from the same bunch, and care was taken to select berries from the top, centre and tail of individual bunches. Berries were cut so as to leave the peduncle intact and avoid damaging the fruit itself. Each bunch was then divided approximately in half by cutting alternate rachis from the main stem. The ‘bunchlets’ were then stored either at 0° C. in the original lined cartons or 20° C. on trays inside loosely sealed plastic bags awaiting assessment. Assessments were conducted as per the schedule shown in Table 11.

TABLE 11
Dates of harvest and testing schedule

| Day | Date | 0° C. | 20° C. | Notes |
|---|---|---|---|---|
| harvest | 15^{th} March | X | X | TA, TSS only |
| 0 | 22^{nd} March | X | X | 20 berries |
| 3 | 25^{th} March | | X | 10 berries |
| 6 | 28^{th} March | X | X | |
| 11 | 2^{nd} April | | X | |
| 14 | 5^{th} April | X | X | |
| 17 | 8^{th} April | | X | |
| 19 | 10^{th} April | X | | |
| 28 | 17^{th} April | X | | |
| 35 | 3^{rd} May | X | | No TA |

### Quality Assessment

### Colour

Colour was measured using a chroma meter (Minolta CR-400, Osaka, Japan). A single reading was taken of the stylar end of each berry (10 readings per rep). Results were converted to the L*a*b* colour scale. The colour was also reported as Hue angle (H°=tan⁻¹(b/a)) where b is the yellow:blue and a is the red:green colour coordinates

In addition, photographs were taken of the same groups of fruit. Berries were positioned in white trays on a black background so as the stylar ends were generally uppermost.

### Titratable Acidity and Total Soluble Solids (Brix)

Each sample of 10 berries was homogeneized using a domestic blender. The resulting pulp was strained through a coarse sieve to remove seeds and larger solid materials. The strained juice was then centrifuged for approximately 10 minutes to separate the clear juice from any remaining solids. Approximately 20 ml of the clear supernatant was extracted for measurement. Soluble solids (%) were determined using a digital refractometer (Atago Pocket Pal-1) calibrated against distilled water. Approximately 17 g of the remaining clear juice was titrated against 0.1M NaOH using an automatic titrator (Metrohm 888 Titrando titrator fitted with a 789 Robotic Sampler Processor XL) and analysed using Tiamo 2.0 software.

### Juice Colour

As described in the methods, juice had been extracted for measurements of TA and TSS. It was observed that there were differences in the colour of the juice samples. However, there is no easy way to measure juice colour with a chromameter.

Photographs were taken of the samples as they were lined up for testing on the laboratory bench. Samples were photographed in pairs by vine number so as to allow comparison of treated and untreated samples. It was possible to calculate the average colour of a portion of each sample in each photograph. Photographs were analysed for the samples taken at harvest and supplied from Western Australia as well as freshly prepared samples that had been filtered and centrifuged. At the final quality assessment, juice samples were analysed using a scanning spectrophotometer. This measures absorbance at a range of wavelengths that include the visible spectrum, and thus acts as another method of measuring colour. Absorbance at specific wavelengths can also indicate the presence of particular compounds. For example, resveratrol (a potent antioxidant found in grapes) absorbs at 290-400 nm wavelengths, depending on the form (cis or trans) in the plant.

### Biometrical Analysis

Data was analysed using CoStat 6.0 statistical software. Significant differences between storage times, replicates and treatments were determined using ANOVA. Means were compared using the Duncans Multiple Range test at the 95% confidence interval.

### Results

### Grape Colour—Minolta Chroma-Meter Data

Changes over time and differences between treatments were greater for the grapes stored at 0° C. compared to those stored at 20° C. Differences between replicates were similar regardless of storage temperature.

Grapes from the four northernmost vines (replicates 1 and 2) were significantly darker (L value, p<0.001) and less yellow (b* value, p<0.001) regardless of storage temperature. Vine 6 stood out as consistently producing the reddest and brightest fruit while fruit from vines 3 and 4 was usually the least coloured.

While small, but statistically significant changes were found between day 0 and day 17 at 20° C., changes over time were greater and more consistent at 0° C. Grapes became slightly redder (a* value increased) and more blue (b* value decreased) during storage, developing a stronger purple colour. Chroma, which is a measure of colour intensity, increased significantly over time at both temperatures (p<0.001).

There were no strongly significant colour differences between treated and untreated grapes at 20° C. At 0° C. differences were statistically significant, although relatively small. Treated grapes were darker (L value, p<0.001), redder (a* value, p<0.001) and bluer (b* value, p<0.001) compared to control fruit. Hue angle values for treated grapes increased at 20° C. (p=0.003) but decreased at 0° C. (p=0.015); in both cases numerical differences were extremely small, but the large number of readings (10 or 20 per vine×8 vines) at each assessment meant that differences were statistically significant.

### Grape Colour—Photographic Method Measurements

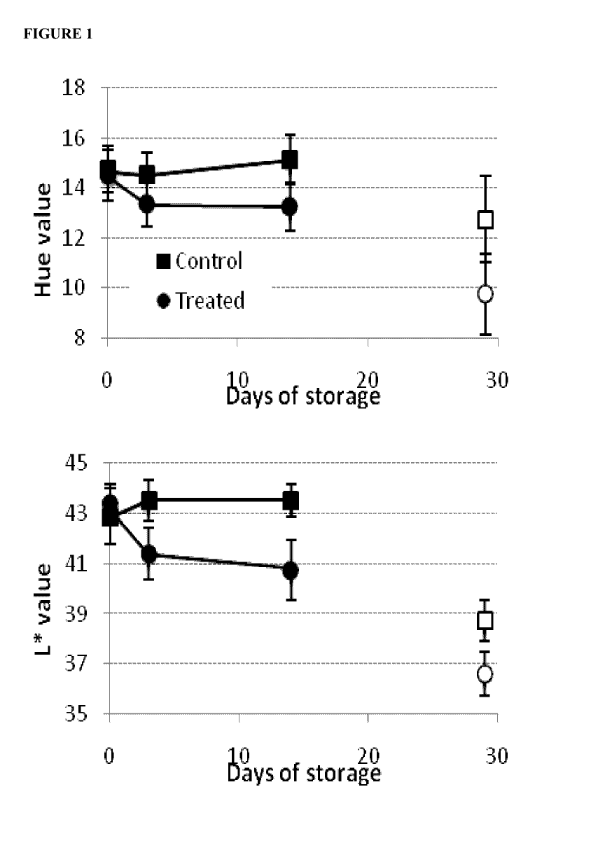

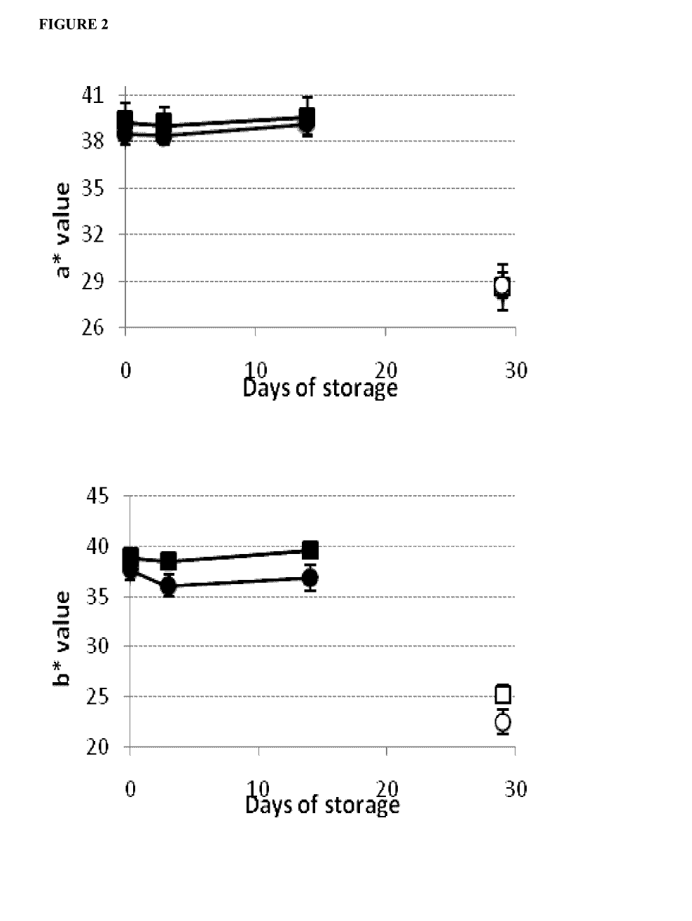

The grape samples used for assessment of colour, TA and TSS were photographed under standard conditions on four separate occasions during the trial. Fruit were piled inside the sample trays in a double layer. The colour of a part of the tray covered by berries was selected and averaged. Using this method, significant differences in colour were found between the treatments in terms of Hue (p=0.0013), R (p<0.001), G (p<0.001), L* (p<0.001), b* (p=0.0012) and K (p<0.001) (see, for example, FIGS. 1 and 2). This indicates that the treated grapes were darker, redder, less yellow and more strongly coloured overall than the control fruit. Moreover, differences in colour (such as L value and Hue) appeared to increase during storage, see, for example FIG. 1).

### Juice Colour

The juice samples that were extracted at harvest and transported with the grapes to Richmond were significantly darker overall than freshly extracted samples (L value, p=0.001). These samples contained not just clear juice but a large amount of skin and other materials. As the majority of anthocyanins are in the grape skin, and these are water soluble so will leach into the juice, it is unsurprising that these samples would have stronger colour.

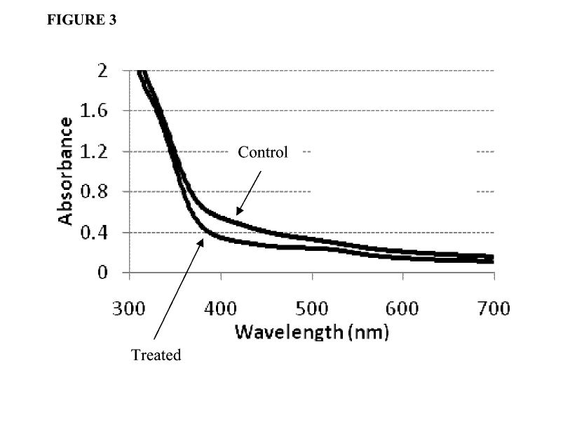

It had been expected that freshly prepared samples, which were filtered and centrifuged immediately after the grapes were crushed, would contain only small amounts of colour compounds such as anthocyanins Juice colour was therefore unlikely to differ between the control and treated fruit. Surprisingly, there proved to be clear observable differences between the treatments (see, for example, FIG. 3). As the differences were similar for the two dates examined, the data was combined to allow statistical analysis. As shown in Table 12, there were clear differences between the treated and untreated samples. Juice from treated grapes was both significantly redder as well as significantly more strongly coloured compared to the control fruit.

TABLE 12
Colour of juice samples from treated and untreated grapes, average
values from two sampling dates and 8 vines per treatment.

| | |
|---|---|
| Colour | Colour values (n = 16) |

| measurement | Significance | Control | Treated |
|---|---|---|---|
| Hue | ** | 29.3 | 23.9 |
| R | * | 186.4 | 168.8 |
| G | *** | 128.4 | 97.8 |
| B | ** | 72.8 | 50.8 |
| L* | ** | 59.0 | 49.3 |
| a* | ** | 19.1 | 26.6 |
| b* | ns | 39.1 | 39.0 |
| K | * | 6.5 | 14.6 |

*** = significance level of 0.001,
** = significance level of 0.01,
* = significance level of 0.05, and
ns = not significant.

There were also significant differences between the replicates. Values for b*, which indicates the transition from yellow to blue, decreased significantly down the row (p<0.001). This suggests that replicate 1 was the most yellow and replicate 4 the least yellow.

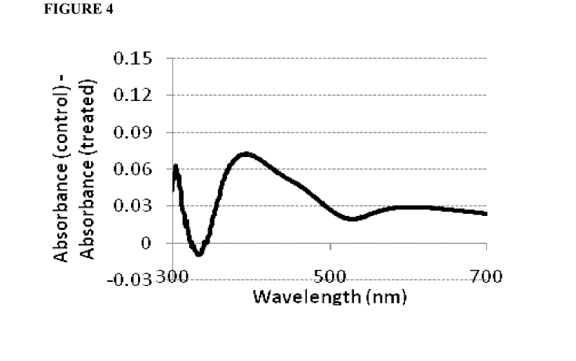

The results from the scanning spectrophotometer also demonstrate a difference between the treated and treated juice samples. Absorbance was higher overall for the control fruit. This was such as marked for the range of wavelengths between 380-400 nm, which corresponds to the range of ultraviolet to purple. However, the treated fruit had increased absorbance—at least as high as control fruit—in the 320-350 nm range (see, for example, FIGS. 3 and 4). This is consistent with the absorbance range for resveratrol, so could possibly indicate there is no decrease in the nutritional properties of the treated juice samples.

Because light is reflected, rather than absorbed, the results are consistent with juice extracted from the treated fruit having stronger colour overall.

### Titratable Acidity and Total Soluble Solids

### Total Soluble Solids (TSS)

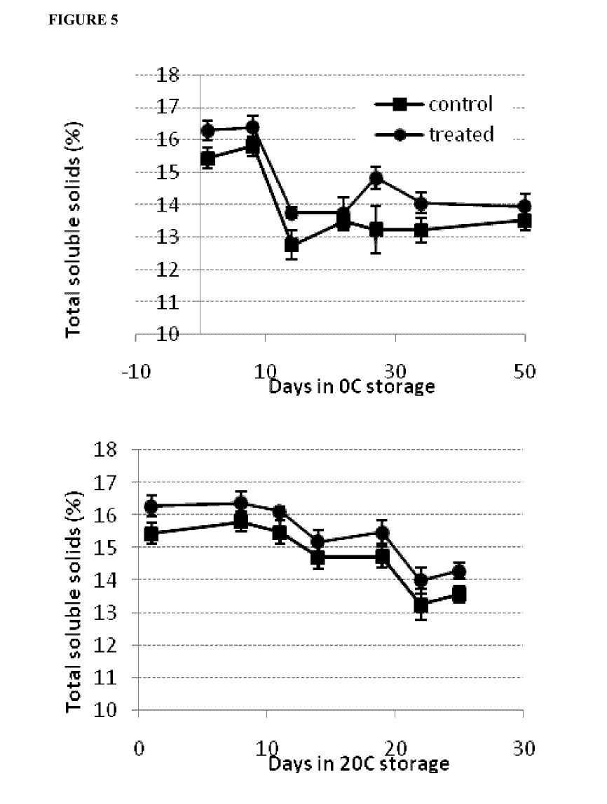

TSS is approximately equal to the sugar content of the juice. TSS was significantly higher (p<0.001) in the treated fruit compared to the untreated fruit. Although TSS declined significantly 8 days after harvest at both 0° C. and 20° C. storage temperatures (p<0.001), the difference between treated and untreated fruit that was observed at harvest was maintained throughout the trial (see, for example, FIG. 5). This indicates that the treated grapes were sweeter than the untreated fruit.

### Titratable Acidity (TA)

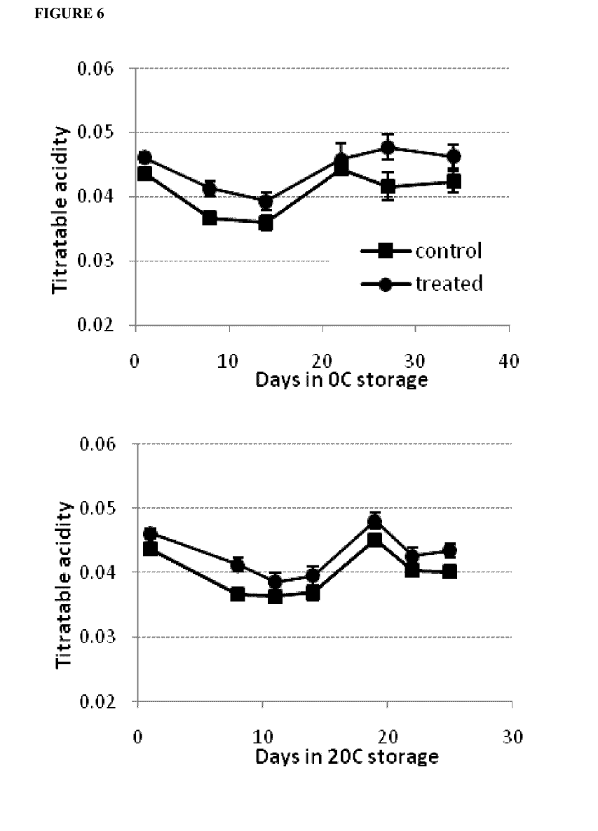

There was a small, but highly statistically significant (p<0.001) increase in TA in treated grapes compared to the untreated fruit. TA was not significantly affected by either storage temperature or storage time, and was relatively low in these grapes. This is typical of the red globe variety. Mean acidity in control fruit for all storage times and temperatures combined was 0.040 mmol equivalents when titrated against 0.1M NaOH. Treated fruit averaged 0.044 mmol equivalents at both storage temperatures (see, for example, FIG. 6). While this difference is numerically small, as it represents an increase in acidity of 10% it could potentially impact on grape flavour.

### Conclusions

The results strongly suggest that treatment with MOVENTO® not only increases colour development in red globe grapes, but also enhances titratable acidity and sugar accumulation. This suggests a significant increase in quality, as grapes higher in both sugar and acid will be more flavoursome while strong colour development is likely to appeal to consumers.

The increase in colour in the juice is of particular interest. If this effect were to also occur in wine grapes, this could have major benefits for viticulturalists aiming to produce richly coloured red wines.

### Example 4

### Menindee Seedless Grapes

A study was carried out to evaluate the effect of MOVENTO® on the size of the berries of Menindee seedless grapes.

MOVENTO® 240SC (240 g ai/L spirotetramat) was applied in two applications at a rate of 40 mL/100 L with an adjuvant (BIOPEST® or AGRIDEX®) to a commercial crop of Menindee seedless grapes. Treatment with MOVENTO® was compared to treatment with TRANSFORM® (40 mL/100 L) (see Table 13) applied in two applications to a commercial crop of Menindee seedless grapes. The two applications were applied 17 days apart for both spraying regimes.

TABLE 13
Spraying regime

| Spray | | | Water | | Block |
|---|---|---|---|---|---|
| No. | Product | Adjuvant | Volume | | Code |
| 1 | MOVENTO ® | Biopest | 600 | L/ha | D, K |
| | 40 mL/100 L | 50 mL/100 L* | | | |
| | TRANSFORM ® | Nil | 600 | L/ha | C, L |
| | 40 mL/100 L | | | | |
| 2 | MOVENTO ® | Agrodex | 1000 | L/ha | D, K |
| | 40 mL/100 L | 50 mL/100 L | | | |
| | TRANSFORM ® | Nil | 1000 | L/ha | C, L |
| | 40 mL/100 L | | | | |

*Note:
The adjuvant Biopest 50 mL/100 L was applied instead of Agridex on spray 1. Normal rate of Biopest is 100 mL/100 L.

### Sampling

The grapes were harvested 7 weeks after the second application from four adjacent rows of Block D and Block C at normal maturity. Paired sampling (two rows per treatment) was used. Five berries/bunch from every second panel and one bunch every tenth panel were sampled and the berry size assessed.

### Harvest Results

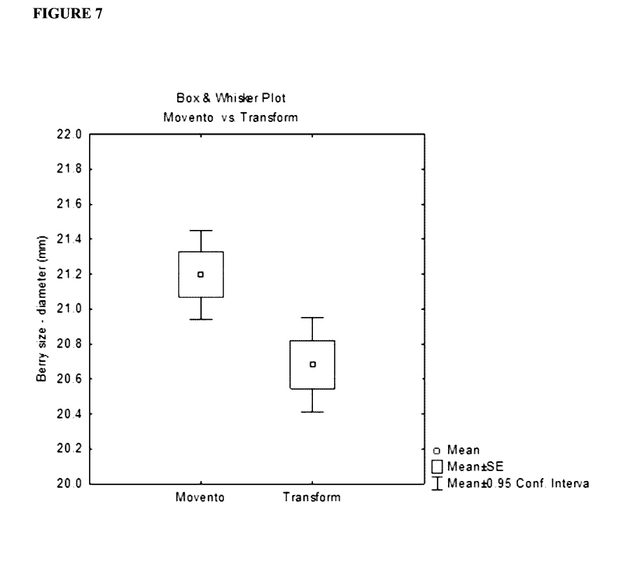

The results from the study indicate that the use of MOVENTO® significantly increases berry size (See FIG. 7). The berry size uniformity also increases with the use of MOVENTO® (33.1% ≦20 mm) compared to TRANSFORM® (44.4% ≦20 mm) The results indicate that there are 11% less berries with a size of ≦20 mm with the use of MOVENTO®.

### Conclusion

The use of MOVENTO® increases the size and uniformity of Menindee seedless grapes.

1. A method for inducing ripeness in a fruit comprising employing a compound of formula I 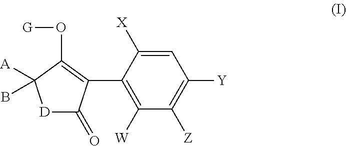
in which
X is selected from halogen, alkyl, alkoxy, haloalkyl, haloalkoxy, or cyano,
W, Y and Z independently of one another are selected from hydrogen, halogen, alkyl, alkoxy, haloalkyl, haloalkoxy, or cyano,
A is selected from hydrogen, alkyl, alkoxyalkyl, optionally substituted cycloalkyl, or optionally substituted heterocycloalkyl, wherein said alkyl and alkoxyalkyl are optionally substituted by halogen,
B is selected from hydrogen or alkyl,
or
A and B together with the carbon atom to which they are attached form a saturated or unsaturated, optionally substituted carbocyclic ring or form a saturated or unsaturated, optionally substituted heterocyclic ring,
D is selected from NH or oxygen,
G is hydrogen (a) or is selected from one of (b) to (g) 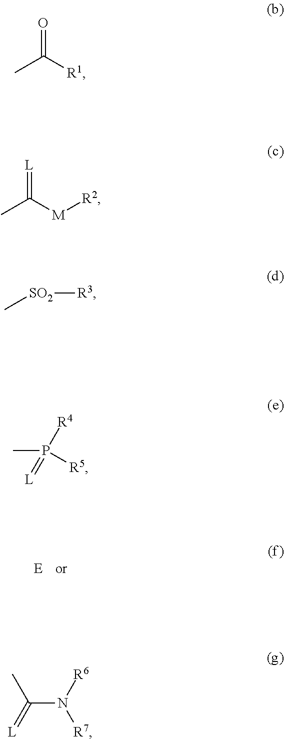
in which
E is selected from a metal ion or an ammonium ion,
L is selected from oxygen or sulphur,
M is selected from oxygen or sulphur,
R¹ is selected from alkyl, alkenyl, alkoxyalkyl, alkylthioalkyl, polyalkoxyalkyl, cycloalkyl, heterocycloalkyl, optionally substituted phenyl, optionally substituted phenylalkyl, optionally substituted hetaryl, optionally substituted phenoxyalkyl, or optionally substituted hetaryloxyalkyl, wherein said alkyl, alkenyl, alkoxyalkyl, alkylthioalkyl, and polyalkoxyalkyl are optionally substituted by halogen and said cycloalkyl and heterocycloalkyl are optionally substituted by halogen-alkyl or halogen-alkoxy,
R² is selected from alkyl, alkenyl, alkoxyalkyl, polyalkoxyalkyl, optionally substituted cycloalkyl, optionally substituted phenyl, or optionally substituted benzyl, wherein said alkyl, alkenyl, alkoxyalkyl, and polyalkoxyalkyl are optionally substituted by halogen,
R³ is selected from alkyl optionally substituted by halogen or optionally substituted phenyl,
R⁴ and R⁵ independently of one another are selected from alkyl, alkoxy, alkylamino, dialkylamino, alkylthio, alkenylthio, cycloalkylthio, optionally substituted phenyl, optionally substituted benzyl, optionally substituted phenoxy, or optionally substituted phenylthio, wherein said alkyl, alkoxy, alkylamino, dialkylamino, alkylthio, alkenylthio, and cycloalkylthio are optionally substituted by halogen, and
R⁶ and R⁷ independently of one another are selected from hydrogen, alkyl, cycloalkyl, alkenyl, alkoxy, alkoxyalkyl, optionally substituted phenyl, or optionally substituted benzyl, or together with the nitrogen atom to which they are attached form an optionally saturated or unsaturated, optionally substituted heterocyclic ring, wherein said alkyl, cycloalkyl, alkenyl, alkoxy, and alkoxyalkyl are optionally substituted by halogen,
wherein said compound can also optionally comprise an isomer mixture, pure isomer, or salt thereof, optionally in combination with one
or more of a carrier, adjuvant, auxiliary, or extender,
and exposing a plant from which the fruit grows, the fruit, roots of the plant, leaves of the plant, seed of the plant, or soil or substrate in which the plant grows or is to be grown to the compound.

2. The method as defined in claim 1, optionally in combination with one or more of a carrier, adjuvant, auxiliary, or extender for reducing the ripening time of a fruit, wherein a plant from which the fruit grows, the fruit, roots of the plant, leaves of the plant, seed of the plant, or soil or substrate in which the plant grows or is to be grown is exposed to the compound.

3. The method as defined in claim 1, optionally in combination with one or more of a carrier, adjuvant, auxiliary, or extender for increasing the palatability of a fruit, wherein a plant from which the fruit grows, the fruit, roots of the plant, leaves of the plant seed of the plant, or soil or substrate in which the plant grows or is to be grown is exposed to the compound.

4. The method as defined in claim 1, optionally in combination with one or more of a carrier, adjuvant, auxiliary, or extender for improving desirable characteristics in a fruit, wherein a plant from which the fruit grows, the fruit, roots of the plant, leaves of the plant, seed of the plant, or soil or substrate in which the plant grows or is to be grown is exposed to the compound.

5. The method as defined in claim 1, optionally in combination with one or more of a carrier, adjuvant, auxiliary, or extender for improving organoleptic properties of a fruit, wherein a plant from which the fruit grows, the fruit, roots of the plant, leaves of the plant, seed of the plant, or soil or substrate in which the plant grows or is to be grown is exposed to the compound.

6. The method according to of claim 1, wherein:
W is selected from hydrogen, C₁-C₄-alkyl, C₁-C₄-alkoxy, chlorine, bromine, or fluorine,
X is selected from C₁-C₄-alkyl, C₁-C₄-alkoxy, C₁-C₄-haloalkyl, fluorine, chlorine, or bromine,
Y and Z independently of one another are selected from hydrogen, C₁-C₄-alkyl, halogen, C₁-C₄-alkoxy, or C₁-C₄-haloalkyl,
A is selected from hydrogen or C₁-C₆-alkyl or C₃-C₈-cycloalkyl, which are each optionally substituted by halogen,
B is selected from hydrogen, methyl, or ethyl, or
A, B and the carbon atom to which they are attached form a saturated C₃-C₆-cycloalkyl or C₃-C₆-heterocycloalkyl which contains one heteroatom selected from oxygen or sulphur, wherein said C₃-C₆-cycloalkyl or C₃-C₆-heterocycloalkyl are optionally substituted by one or two C₁-C₄-alkyl, or C₁-C₄-alkoxy groups,
D is selected from NH or oxygen,
G is hydrogen (a) or is selected from one of the groups (b) to (g) 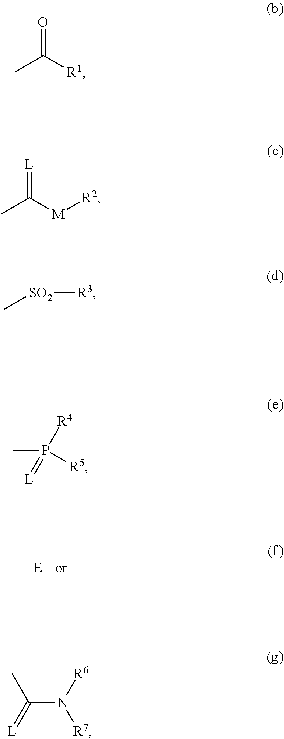
in which
E is selected from a metal ion or an ammonium ion,
L is selected from oxygen or sulphur,
M is selected from oxygen or sulphur,
R¹ is selected from C₁-C₁₀-alkyl, C₂-C₁₀-alkenyl, C₁-C₄-alkoxy-C₁-C₄-alkyl, C₁-C₄-alkylthio-C₁-C₄-alkyl, C₃-C₆-cycloalkyl, phenyl, pyridyl, or thienyl, wherein said C₁-C₁₀-alkyl, C₂-C₁₀-alkenyl, C₁-C₄-alkoxy-C₁-C₄-alkyl, and C₁-C₄-alkylthio-C₁-C₄-alkyl are optionally substituted by halogen, said C₃-C₆-cycloalkyl is optionally substituted by fluorine, chlorine, C₁-C₄-alkyl, or C₁-C₂-alkoxy, said phenyl is optionally substituted by fluorine, chlorine, bromine, cyano, nitro, C₁-C₄-alkyl, C₁-C₄-alkoxy, trifluoromethyl, or trifluoromethoxy, and said pyridyl and thienyl are optionally substituted by chlorine or methyl,
R² is selected from C₁-C₁₀-alkyl, C₂-C₁₀-alkenyl, C₁-C₄-alkoxy-C₂-C₄-alkyl, C₅-C₆-cycloalkyl, phenyl, or benzyl, wherein said C₁-C₁₀-alkyl, C₂-C₁₀-alkenyl, and C₁-C₄-alkoxy-C₂-C₄-alkyl are optionally substituted by fluorine or chlorine, said C₅-C₆-cycloalkyl is optionally substituted by methyl or methoxy, and said phenyl and benzyl are optionally substituted by fluorine, chlorine, bromine, cyano, nitro, C₁-C₄-alkyl, C₁-C₄-alkoxy, trifluoromethyl, or trifluoromethoxy,
R³ is selected from C₁-C₄-alkyl or phenyl, wherein said C₁-C₄-alkyl is optionally substituted by fluorine and said phenyl is optionally substituted by fluorine, chlorine, bromine, C₁-C₄-alkyl, C₁-C₄-alkoxy, trifluoromethyl, trifluoromethoxy, cyano, or nitro,
R⁴ is selected from C₁-C₄-alkyl, C₁-C₄-alkoxy, C₁-C₄-alkylamino, C₁-C₄-alkylthio, phenyl, phenoxy, or phenylthio, wherein said C₁-C₄-alkyl, C₁-C₄-alkoxy, C₁-C₄-alkylamino, and C₁-C₄-alkylthio are optionally substituted by fluorine or chlorine and said phenyl, phenoxy, and phenylthio are optionally substituted by fluorine, chlorine, bromine, nitro, cyano, C₁-C₄-alkoxy, trifluoromethoxy, C₁-C₄-alkylthio, C₁-C₄-haloalkylthio, C₁-C₄-alkyl, or trifluoromethyl,
R⁵ is selected from C₁-C₄-alkoxy or C₁-C₄-thioalkyl,
R⁶ is selected from C₁-C₆-alkyl, C₃-C₆-cycloalkyl, C₁-C₆-alkoxy, C₃-C₆-alkenyl, or C₁-C₄-alkoxy-C₁-C₄-alkyl,
R⁷ is selected from C₁-C₆-alkyl, C₃-C₆-alkenyl, or C₁-C₄-alkoxy-C₁-C₄-alkyl, or
R⁶ and R⁷ together with the nitrogen to which they are attached form a C₃-C₆-heterocycloalkylene group which optionally has one carbon atom replaced by oxygen or sulphur, wherein said C₃-C₆-heterocycloalkylene group is optionally substituted by methyl or ethyl.

7. The method according to claim 1, wherein:
G is hydrogen (a) or is selected from one of the groups (b), (c), (f) or (g) 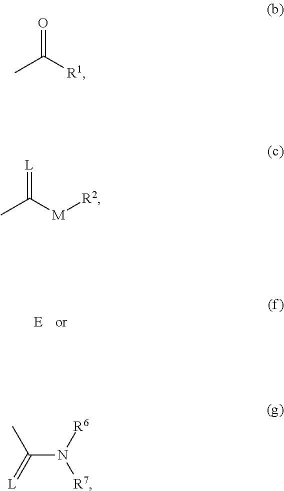
in which
E is selected from a metal ion or an ammonium ion,
L is selected from oxygen or sulphur,
M is selected from oxygen or sulphur,
R¹ is selected from C₁-C₁₀-alkyl, C₂-C₁₀-alkenyl, C₁-C₄-alkoxy-C₁-C₄-alkyl, C₁-C₄-alkylthio-C₁-C₄-alkyl, C₃-C₆-cycloalkyl, phenyl, pyridyl, or thienyl, wherein said C₁-C₁₀-alkyl, C₂-C₁₀-alkenyl, C₁-C₄-alkoxy-C₁-C₄-alkyl, and C₁-C₄-alkylthio-C₁-C₄-alkyl are optionally substituted by halogen, said C₃-C₆-cycloalkyl is optionally substituted by fluorine, chlorine, C₁-C₄-alkyl, or C₁-C₂-alkoxy, said phenyl is optionally substituted by fluorine, chlorine, bromine, cyano, nitro, C₁-C₄-alkyl, C₁-C₄-alkoxy, trifluoromethyl, or trifluoromethoxy, and said pyridyl or thienyl are optionally substituted by chlorine or methyl,
R² is selected C₁-C₁₀-alkyl, C₂-C₁₀-alkenyl, C₁-C₄-alkoxy-C₂-C₄-alkyl, C₅-C₆-cycloalkyl, phenyl or benzyl, wherein said C₁-C₁₀-alkyl, C₂-C₁₀-alkenyl, and C₁-C₄-alkoxy-C₂-C₄-alkyl are optionally substituted by fluorine or chlorine, said C₅-C₆-cycloalkyl is optionally substituted by methyl or methoxy, and said phenyl and benzyl are optionally substituted by fluorine, chlorine, bromine, cyano, nitro, C₁-C₄-alkyl, C₁-C₄-alkoxy, trifluoromethyl, or trifluoromethoxy,
R⁶ is selected from C₁-C₆-alkyl, C₃-C₆-cycloalkyl, C₁-C₆-alkoxy, C₃-C₆-alkenyl, or C₁-C₄-alkoxy-C₁-C₄-alkyl, and
R⁷ is selected from C₁-C₆-alkyl, C₃-C₆-alkenyl, or C₁-C₄-alkoxy-C₁-C₄-alkyl.

8. The method according to claim 1, wherein:
W is selected from hydrogen, methyl, ethyl, chlorine, bromine, or methoxy,
X is selected from chlorine, bromine, methyl, ethyl, propyl, isopropyl, methoxy, ethoxy, or trifluoromethyl,
Y and Z independently of one another are selected from hydrogen, fluorine, chlorine, bromine, methyl, ethyl, propyl, isopropyl, trifluoromethyl, or methoxy,
A is selected from methyl, ethyl, propyl, isopropyl, butyl, isobutyl, sec-butyl, tert-butyl, cyclopropyl, cyclopentyl, or cyclohexyl,
B is selected from hydrogen, methyl, or ethyl,
or
A, B and the carbon atom to which they are attached form a saturated C₅-C₆-cycloalkyl or C₅-C₆-heterocycloalkyl which has one ring member replaced by oxygen, wherein said C₅-C₆-cycloalkyl and C₅-C₆-heterocycloalkyl are optionally monosubstituted by methyl, ethyl, methoxy, ethoxy, propoxy, or butoxy,
D is selected from NH or oxygen,
G is hydrogen (a) or is selected from one of the groups (b), (c), (f), or (g) 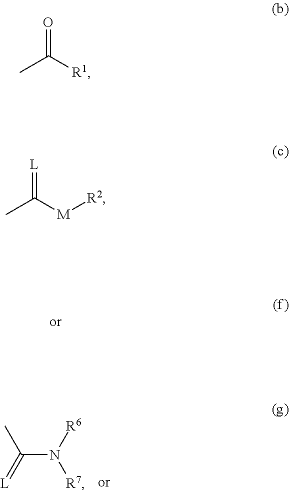
in which
E is selected from a metal ion or an ammonium ion,
M is selected from oxygen or sulphur,
R¹ is selected from C₁-C₈-alkyl, C₂-C₄-alkenyl, methoxymethyl, ethoxymethyl, ethylthiomethyl, cyclopropyl, cyclopentyl, cyclohexyl, phenyl, pyridyl, or thienyl, wherein said phenyl is optionally mono- or disubstituted by fluorine, chlorine, bromine, cyano, nitro, methyl, ethyl, methoxy, trifluoromethyl, or trifluoromethoxy and said pyridyl and thienyl are optionally substituted by chlorine or methyl,
R² is selected from C₁-C₈-alkyl, C₂-C₄-alkenyl, methoxyethyl, ethoxyethyl, phenyl, or benzyl,
R⁶ and R⁷ independently of one another are selected from methyl, ethyl, or together with the nitrogen to which they are attached from a C₅-heteroalkylene radical in which the C₃-methylene group has been replaced by an oxygen.

9. The method according to claim 1, wherein:
W is selected from hydrogen or methyl,
X is selected from chlorine, bromine, or methyl,
Y and Z independently of one another are selected from hydrogen, chlorine, bromine, or methyl,
A, B and the carbon atom to which they are attached form a C₅-C₆-cycloalkyl or C₅-C₆-heterocycloalkyl which has one ring member replaced by oxygen, wherein said C₅-C₆-cycloalkyl and C₅-C₆-heterocycloalkyl are optionally monosubstituted by methyl, methoxy, ethoxy, propoxy, or butoxy,
D is selected from NH or oxygen,
G is hydrogen (a) or is selected from one of the groups (b), (c), or (g) 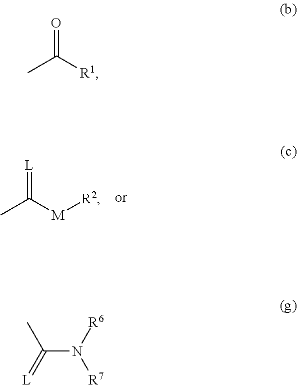
in which
M is selected from oxygen or sulphur,
R¹ is selected from C₁-C₈-alkyl, C₂-C₄-alkenyl, methoxymethyl, ethoxymethyl, ethylthiomethyl, cyclopropyl, cyclopentyl, cyclohexyl, phenyl, pyridyl, or thienyl, wherein said phenyl is optionally monosubstituted by fluorine, chlorine, bromine, methyl, methoxy, trifluoromethyl, trifluoromethoxy, cyano, or nitro and said pyridyl and theinyl are optionally substituted by chlorine or methyl,
R² is selected from C₁-C₈-alkyl, C₂-C₄-alkenyl, methoxyethyl, ethoxyethyl, phenyl, or benzyl,
R⁶ and R⁷ independently of one another is selected from methyl, ethyl, or together with the nitrogen to which they are attached form a C₅-heteroalkylene radical in which the C₃-methylene group has been replaced by an oxygen.

10. The method according to claim 1, wherein the compound of formula I is selected from the group consisting of 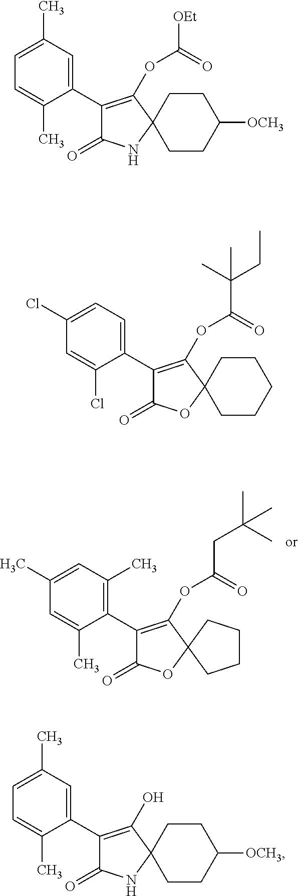 [SMILES: CCOC(=O)OC1=C(c2cc(C)ccc2C)C(=O)NC12CCC(OC)CC2 ; CCC(C)(C)C(=O)OC1=C(c2ccc(Cl)cc2Cl)C(=O)OC12CCCCC2 ; Cc1cc(C)c(C2=C(OC(=O)CC(C)(C)C)C3(CCCC3)OC2=O)c(C)c1 ; COC1CCC2(CC1)NC(=O)C(c1cc(C)ccc1C)=C2O]
or an isomer mixture, pure isomer, or salt thereof.

11. The method according to claim 1, wherein the compound of formula I is 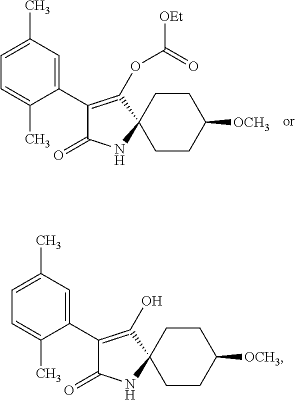 [SMILES: CCOC(=O)OC1=C(c2cc(C)ccc2C)C(=O)N[C@]12CC[C@@H](OC)CC2 ; "or" ; CO[C@H]1CC[C@]2(CC1)NC(=O)C(c1cc(C)ccc1C)=C2O]
or an isomer mixture, pure isomer, or salt thereof.

12. The method according to claim 1, wherein the compound of formula I is 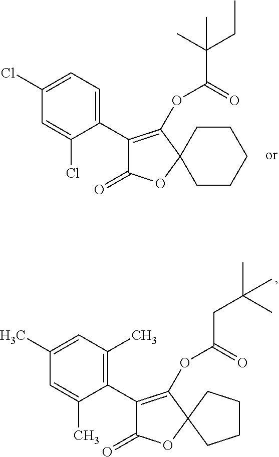 [SMILES: CCC(C)(C)C(=O)OC1=C(c2ccc(Cl)cc2Cl)C(=O)OC12CCCCC2 ; "or" ; Cc1cc(C)c(C2=C(OC(=O)CC(C)(C)C)C3(CCCC3)OC2=O)c(C)c1]
or an isomer mixture, pure isomer, or salt thereof.

13. The method according to claim 1, wherein the compound of formula I is 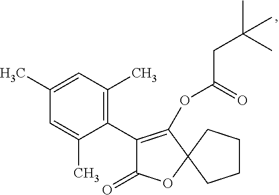 [SMILES: Cc1cc(C)c(C2=C(OC(=O)CC(C)(C)C)C3(CCCC3)OC2=O)c(C)c1]
or an isomer mixture, pure isomer, or salt thereof.

14. The method according to claim 1, wherein the compound of formula I is 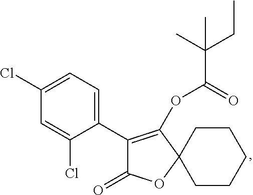 [SMILES: CCC(C)(C)C(=O)OC1=C(c2ccc(Cl)cc2Cl)C(=O)OC12CCCCC2]
or an isomer mixture, pure isomer, or salt thereof.

15. The method according to claim 1, wherein the compound of formula I is 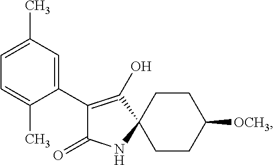 [SMILES: CO[C@H]1CC[C@]2(CC1)NC(=O)C(c1cc(C)ccc1C)=C2O]
or a salt thereof.

16. The method according to claim 1, wherein the compound of formula I is 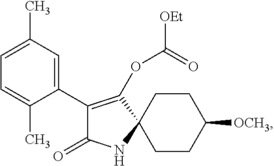 [SMILES: CCOC(=O)OC1=C(c2cc(C)ccc2C)C(=O)N[C@]12CC[C@@H](OC)CC2]
or a salt thereof.

17. The method according to claim 1, wherein the adjuvant is predominantly comprised of a methyl or ethyl ester, or any mixture thereof, of fatty acids originating from a plant oil.

18. The method according to claim 17, wherein the plant oil is selected from sunflower oil, canola oil, rapeseed oil, soybean oil, and/or corn oil.

19. The method according to claim 1, wherein the adjuvant is a polyalkoxylated triglyceride.

20. The method according to claim 1, wherein the adjuvant is a polyethoxylated C₈-C₁₀ fatty alcohol.

21. The method according to claim 1, wherein the adjuvant is a polyalkoxylated C₈-C₁₀ fatty alcohol.

22. The method according to claim 1, wherein the fruit is selected from the group comprising citrus, pome or stone fruit, berries or grapes.

23. The method according to claim 22, wherein the pome fruit is selected from apples or pears.

24. The method according to claim 22, wherein the stone fruit is selected from the group comprising plums, peaches, apricots, or nectarines.

25. The method according to claim 22, wherein the berries are selected from the group comprising blueberries, raspberries, strawberries, or blackberries.

26. The method according to claim 1, wherein the fruit is grapes.

27. The method according to claim 26, wherein the grapes are table grapes or wine grapes.

28. The method according to claim 1, wherein the compound of formula I is applied to the fruit and/or plant.

29. The method according to claim 1, wherein the compound of formula I is applied to the leaves of the plant.

30. The method according to claim 1, wherein the compound of formula I is applied by spraying.

31. The method according to claim 1, wherein the compound of formula I is applied with one or more further agriculturally acceptable compounds.

32. The method according to claim 31, wherein the one or more further agriculturally acceptable compounds are selected from the group comprising herbicides, pesticides, insecticides, fungicides, or plant or fruit growth promoting agents.

33. The method according to claim 1, wherein the fruit exposed to a compound of formula I has a TSS (total soluble solids) content and/or a TA (titratable acidity) value that is higher than the TSS and/or TA of fruit that has not been exposed to a compound of formula I.

34. Fruit juice obtained from fruit which has been exposed to a compound of formula I 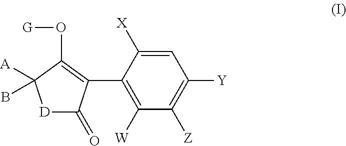
in which
X is selected from halogen, alkyl, alkoxy, haloalkyl, haloalkoxy, or cyano,
W, Y and Z independently of one another are selected from hydrogen, halogen, alkyl, alkoxy, haloalkyl, haloalkoxy, or cyano,
A is selected from hydrogen, alkyl, alkoxyalkyl, optionally substituted cycloalkyl, or optionally substituted heterocycloalkyl, wherein said alkyl and alkoxyalkyl are optionally substituted by halogen,
B is selected from hydrogen or alkyl,
or
A and B together with the carbon atom to which they are attached form a saturated or unsaturated, optionally substituted carbocyclic ring or form a saturated or unsaturated, optionally substituted heterocyclic ring,
D is selected from NH or oxygen,
G is hydrogen (a) or is selected from one of (b) to (g) 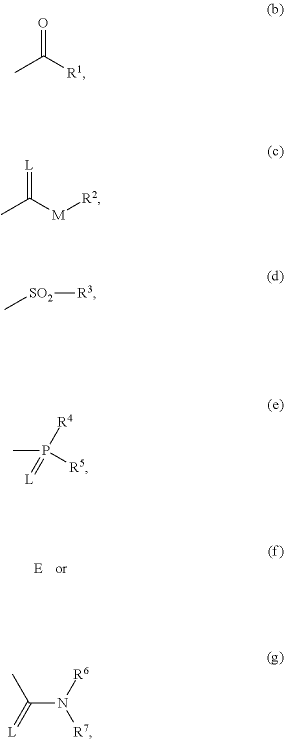
in which
E is selected from a metal ion or an ammonium ion,
L is selected from oxygen or sulphur,
M is selected from oxygen or sulphur,
R¹ is selected from alkyl, alkenyl, alkoxyalkyl, alkylthioalkyl, polyalkoxyalkyl, cycloalkyl, heterocycloalkyl, optionally substituted phenyl, optionally substituted phenylalkyl, optionally substituted hetaryl, optionally substituted phenoxyalkyl, or optionally substituted hetaryloxyalkyl, wherein said alkyl, alkenyl, alkoxyalkyl, alkylthioalkyl, and polyalkoxyalkyl are optionally substituted by halogen and said cycloalkyl and heterocycloalkyl are optionally substituted by halogen-alkyl or halogen-alkoxy,
R² is selected from alkyl, alkenyl, alkoxyalkyl, polyalkoxyalkyl, optionally substituted cycloalkyl, optionally substituted phenyl, or optionally substituted benzyl, wherein said alkyl, alkenyl, alkoxyalkyl, and polyalkoxyalkyl are optionally substituted by halogen,
R³ is selected from alkyl optionally substituted by halogen or optionally substituted phenyl,
R⁴ and R⁵ independently of one another are selected from alkyl, alkoxy, alkylamino, dialkylamino, alkylthio, alkenylthio, cycloalkylthio, optionally substituted phenyl, optionally substituted benzyl, optionally substituted phenoxy, or optionally substituted phenylthio, wherein said alkyl, alkoxy, alkylamino, dialkylamino, alkylthio, alkenylthio, and cycloalkylthio are optionally substituted by halogen, and
R⁶ and R⁷ independently of one another are selected from hydrogen, alkyl, cycloalkyl, alkenyl, alkoxy, alkoxyalkyl, optionally substituted phenyl, or optionally substituted benzyl, or together with the nitrogen atom to which they are attached form an optionally saturated or unsaturated, optionally substituted heterocyclic ring, wherein said alkyl, cycloalkyl, alkenyl, alkoxy, and alkoxyalkyl are optionally substituted by halogen,
wherein said compound can also optionally comprise an isomer mixture, pure isomer, or salt thereof, optionally in combination with one
or more of a carrier, adjuvant, auxiliary, or extender.

35. A fruit juice according to claim 34, which is darker in colour than fruit juice obtained from fruit that has not been exposed to a compound of formula I.
